(19) United States
(12) Patent Application Publication
(10) Pub. No.: US 2026/0221103 A1
(43) Pub. Date: Jul. 30, 2026

(54) STAGE CIRCUIT, DISPLAY DEVICE INCLUDING THE SAME, AND ELECTRONIC DEVICE

(71) Applicant: Samsung Display Co., Ltd., Yongin-si (KR)

(72) Inventors: Hyeong Seok KIM, Yongin-si (KR); Kyung Ho KIM, Yongin-si (KR); Yun Mi KIM, Yongin-si (KR); Do Yeong PARK, Yongin-si (KR); Dong Hee SHIN, Yongin-si (KR); Byung Chang YU, Yongin-si (KR)

(21) Appl. No.: 19/377,826

(22) Filed: Nov. 3, 2025

(30) Foreign Application Priority Data
Jan. 24, 2025 (KR) 10-2025-0010884

(51) Int. Cl. G09G 3/3266; G09G 3/32

(52) U.S. Cl. CPC G09G 3/3266; G09G 3/32; G09G 2300/0819; G09G 2310/0267; G09G 2320/0233; G09G 2320/0257; G09G 2330/021

(57) ABSTRACT

A stage circuit includes a controller connected to first and second power input terminals, to first and second carry input terminals, and to an initialization terminal, and configured to control a voltage of a connection control line, a driver configured to control voltages of first and second nodes, first outputs configured to supply scan clock signals as an enable scan signal to first output terminals based on voltages of first local nodes, second outputs configured to supply initialization clock signals as an enable initialization signal to second output terminals based on voltages of second local nodes, first connectors configured to control electrical connections between the first node and the first local nodes based on a voltage of the connection control line, and second connectors configured to control electrical connections between the first node and the second local nodes based on the voltage of the connection control line.

### CROSS-REFERENCE TO RELATED APPLICATION

The present application claims priority to, and the benefit of, Korean Patent Application Number 10-2025-0010884, filed on January 24, 2025, in the Korean Intellectual Property Office, the entire disclosure of which is incorporated herein by reference.

### BACKGROUND

### 1. Field

Aspects of embodiments of the present disclosure relate to a stage circuit, a display device including the same, and an electronic device.

### 2. Description of the Related Art

With the development of information technology, the importance of a display device, which is a connection medium between a user and information, is being highlighted. Accordingly, the use of display devices such as liquid crystal display devices and organic light-emitting display devices is increasing.

A display device includes pixels, and the pixels may receive a data signal in response to a scan signal supplied from a scan driver, and may emit light at a luminance corresponding to the data signal. The scan driver may include a plurality of stage circuits to supply a scan signal.

### SUMMARY

The present disclosure provides a stage circuit in which a mounting area is reduced or minimized, a display device including the stage circuit, and an electronic device.

According to an aspect of embodiments of the present disclosure, a stage circuit may include a controller connected to a first power input terminal, to a second power input terminal, to a first carry input terminal, to a second carry input terminal, and to an initialization terminal, and configured to control a voltage of a connection control line, a driver configured to control a voltage of a first node and a voltage of a second node, first outputs configured to supply scan clock signals as an enable scan signal to first output terminals based on voltages of first local nodes, second outputs configured to supply initialization clock signals as an enable initialization signal to second output terminals based on voltages of second local nodes, first connectors configured to control electrical connections between the first node and the first local nodes based on a voltage of the connection control line, and second connectors configured to control electrical connections between the first node and the second local nodes based on the voltage of the connection control line.

The first connectors may be configured to electrically connect the first node and the first local nodes during a first period of a period in which the first node is set to a high-level voltage, and to block the electrical connections between the first node and the first local nodes during a second period of the period in which the first node is set to the high-level voltage.

The second connectors may be configured to electrically connect the first node and the second local nodes during a first period of a period in which the first node is set to a high-level voltage, and to block the electrical connections between the first node and the second local nodes during a second period of the period in which the first node is set to the high-level voltage.

The stage circuit may further include a carry output connected to a carry clock input terminal configured to receive a carry clock signal and to a third power input terminal, and configured to connect a carry output terminal to the carry clock input terminal or to the third power input terminal based on the voltage of the first node and the voltage of the second node.

First power of the first power input terminal and second power of the second power input terminal may be positive voltages, wherein third power of the third power input terminal is a negative voltage.

When a carry signal is an i-th carry signal, an (i-1)-th carry signal may be input to the first carry input terminal, and an (i+1)-th carry signal is input to the second carry input terminal.

The carry output may include a first carry transistor connected between the carry clock input terminal and the carry output terminal, and having a gate electrode connected to the first node, and a second carry transistor connected between the carry output terminal and the third power input terminal, and having a gate electrode connected to the second node.

The stage circuit may further include a booster connected to a boosting clock input terminal configured to receive a boosting clock and to a third power input terminal, and connecting a voltage control line to the boosting clock input terminal or to the third power input terminal based on the voltage of the first node and the voltage of the second node.

The booster may include a first boosting transistor connected between the boosting clock input terminal and the voltage control line, and having a gate electrode connected to the first node, a second boosting transistor connected between the voltage control line and the third power input terminal, and having a gate electrode connected to the second node, and a first capacitor connected between the first node and the voltage control line.

The first connectors may include a switching transistor connected between one of the first local nodes and the first node, and having a gate electrode connected to the connection control line, and a boosting capacitor connected between the one of the first local nodes and the voltage control line.

The second connectors may include a switching transistor connected between one of the second local nodes and the first node, and having a gate electrode connected to the connection control line, and a boosting capacitor connected between the one of the second local nodes and the voltage control line.

The controller may include a control transistor connected between the first power input terminal and the connection control line, and having a gate electrode connected to the initialization terminal, a first control transistor connected between the first power input terminal and the connection control line, and having a gate electrode connected to the first carry input terminal, a second control transistor connected between the second power input terminal and the connection control line, and having a gate electrode connected to the voltage control line, and a third control transistor connected between the second power input terminal and the connection control line, and having a gate electrode connected to the second carry input terminal.

The first outputs may include a first output transistor connected between one of scan clock input terminals configured to receive the scan clock signals and one of the first output terminals, and having a gate electrode connected to one of the first local nodes, and a second output transistor connected between a fourth power input terminal and the one of the first output terminals, and having a gate electrode connected to the second node.

The second outputs may include a first output transistor connected between one of initialization clock input terminals configured to receive the initialization clock signals and one of the second output terminals, and having a gate electrode connected to one of the first local nodes, and a second output transistor connected between a fourth power input terminal and the one of the second output terminals, and having a gate electrode connected to the second node.

The stage circuit may further include a reset connected between the connection control line and a fourth power input terminal, and configured to control a connection between the connection control line and the fourth power input terminal in response to the voltage of the second node or a reset signal of a reset input terminal.

The reset may include at least one first reset transistor connected between the connection control line and the fourth power input terminal, and having a gate electrode connected to the second node, and at least one second reset transistor connected between the connection control line and the fourth power input terminal, and having a gate electrode connected to the reset input terminal.

According to an aspect of embodiments of the present disclosure, a display device may include pixels connected to scan lines, initialization lines, and data lines, and a scan driver including stage circuits configured to supply a scan signal to the scan lines and an initialization signal to the initialization lines, at least one of the stage circuits including a controller connected to a first power input terminal, to a second power input terminal, to a first carry input terminal, to a second carry input terminal, and to an initialization terminal, and configured to control a voltage of a connection control line, a driver configured to control a voltage of a first node and a voltage of a second node, first outputs configured to supply scan clock signals as an enable scan signal to first output terminals based on voltages of first local nodes, second outputs configured to supply initialization clock signals as an enable initialization signal to second output terminals based on voltages of second local nodes, first connectors configured to control electrical connections between the first node and the first local nodes based on a voltage of the connection control line, and second connectors configured to control electrical connections between the first node and the second local nodes based on the voltage of the connection control line.

The first connectors may electrically disconnect the first node and the first local nodes during a period in which the enable scan signal is output to the first output terminals, wherein the second connectors electrically disconnect the first node and the second local nodes during a period in which the enable initialization signal is output to the second output terminals.

According to an aspect of embodiments of the present disclosure, an electronic device may include a processor, a display module for displaying an image based on image data supplied from the processor, pixels included in the display module and connected to scan lines, to initialization lines, and to data lines, and a scan driver in the display module, and including stage circuits configured to supply a scan signal to the scan lines and an initialization signal to the initialization lines, at least one of the stage circuits including a controller connected to a first power input terminal, to a second power input terminal, to a first carry input terminal, to a second carry input terminal, and to an initialization terminal, and configured to control a voltage of a connection control line, a driver configured to control a voltage of a first node and a voltage of a second node, first outputs configured to supply scan clock signals as an enable scan signal to first output terminals based on voltages of first local nodes, second outputs configured to supply initialization clock signals as an enable initialization signal to second output terminals based on voltages of second local nodes, first connectors configured to control electrical connections between the first node and the first local nodes based on a voltage of the connection control line, and second connectors configured to control electrical connections between the first node and the second local nodes based on the voltage of the connection control line.

The first connectors may electrically disconnect the first node and the first local nodes during a period in which the enable scan signal is output to the first output terminals, wherein the second connectors electrically disconnect the first node and the second local nodes during a period in which the enable initialization signal is output to the second output terminals.

### BRIEF DESCRIPTION OF THE DRAWINGS

The above and other aspects of embodiments according to the present disclosure will become more apparent by describing, in further detail, aspects of some embodiments thereof with reference to the accompanying drawings, in which:

FIG. 1 is a diagram illustrating a display device according to one or more embodiments of the present disclosure.

FIG. 2 is a circuit diagram illustrating one or more embodiments of a pixel shown in FIG. 1.

FIG. 3 is a diagram illustrating one or more embodiments of a scan driver shown in FIG. 1.

FIGS. 4A and 4B are block diagrams of an i-th stage circuit shown in FIG. 3 according to one or more embodiments of the present disclosure.

FIG. 5 is a circuit diagram showing one or more embodiments of a controller, a booster, a carry output, first outputs, and connectors shown in FIG. 4A.

FIG. 6 is a circuit diagram illustrating one or more embodiments of second outputs, connectors, and a reset shown in FIG. 4B.

FIG. 7 is a waveform diagram showing one or more embodiments of a method of driving a stage circuit shown in FIGS. 5 and 6.

FIGS. 8A, 8B, 9A, 9B, 10A and 10B are diagrams illustrating operation processes of a stage circuit corresponding to the driving waveform of FIG. 7.

FIG. 11 is a diagram showing one or more embodiments of a driver shown in FIG. 4A

FIG. 12 is a waveform diagram showing an operation process of a driver shown in FIG. 11.

FIG. 13 is a diagram illustrating an electronic device according to one or more embodiments of the present disclosure.

FIGS. 14 to 17 are diagrams illustrating an electronic device according to various embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as

examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When "C to D" is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/- 5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

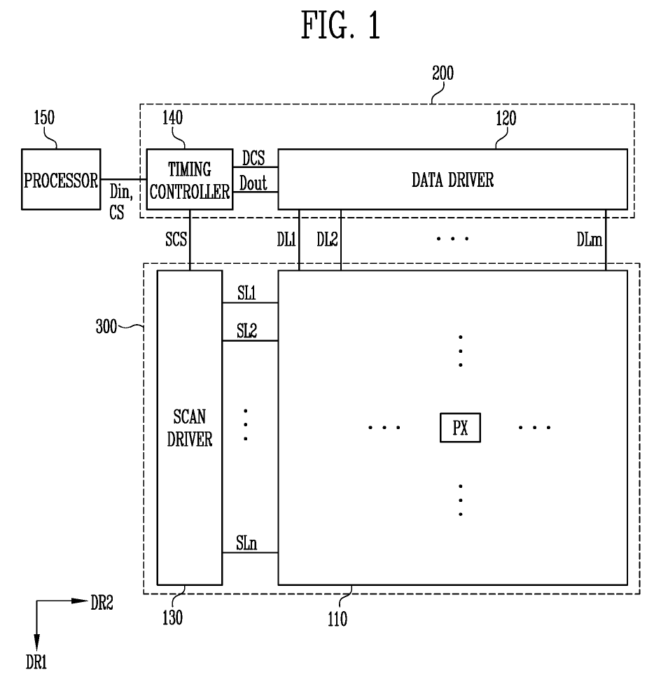

FIG. 1 is a diagram illustrating a display device according to one or more embodiments of the present disclosure.

Referring to FIG. 1, a display device according to one or more embodiments of the present disclosure may include a display driver 200 and a display 300.

The display driver 200 may control the display 300. The display driver 200 may include a timing controller 140 and a data driver 120. The display driver 200 may be composed of one IC or a plurality of ICs. The display 300 may display an image (e.g., predetermined image). The display 300 may include a pixel (e.g., pixel unit) 110 and a scan driver 130.

The timing controller 140 may receive input data Din and control signals CS corresponding to respective frames from a processor 150. The processor 150 may correspond to a Graphics Processing Unit (GPU), a Central Processing Unit (CPU), an Application Processor (AP), or the like. The control signals CS may include various signals for driving the display device. The input data Din may correspond to an image displayed in the pixel 110.

The timing controller 140 may rearrange the input data Din to meet the specifications of the display device. In addition, the timing controller 140 may generate output data Dout by correcting the input data Din, and may supply the output data Dout to the data driver 120. For example, the timing controller 140 may generate the output data Dout by correcting the input data Din by reflecting optical measurement results.

In one or more embodiments, the timing controller 140 may generate a data-driving signal DCS and a scan-driving signal SCS in response to the control signal CS. The data-driving signal DCS may be supplied to the data driver 120, and the scan-driving signal SCS may be supplied to the scan driver 130.

The pixel 110 may include pixels PX, which are positioned to be connected to scan lines SL1, SL2, ..., and SLn, where n is natural number of 3 or more, and data lines DL1, DL2, ..., and DLm, where m is a natural number of three or more.

The data lines DL1 to DLm may be arranged to extend in a first direction DR1. The first direction DR1 may be, for example, a direction in which the upper side and the lower side of the pixel 110 are connected to each other. Alternatively, the first direction DR1 may be a direction in which the left side and the right side of the pixel 110 are connected to each other, or may refer to another direction.

The scan lines SL1 to SLn may be arranged to extend in a second direction DR2. The second direction DR2 may be orthogonal to the first direction DR1. The second direction DR2 may be a direction in which the left side and the right side of the pixel 110 are connected. Alternatively, the second direction DR2 may be a direction in which the upper side and the lower side of the pixel 110 are connected, or may refer to another direction.

The plurality of pixels PX may be arranged in the pixel 110 so as to be electrically connected to the data lines DL1 to DLm and the scan lines SL1 to SLn. The pixels PX may be sub-pixels. For example, the pixels PX may be arranged in a variety of currently known ways.

When a scan signal is supplied to the scan lines SL1 to SLn, the pixels PX are selected in units of horizontal lines (for example, the pixels PX connected to the same scan line may be classified into one horizontal line (or a pixel row)), and the pixels PX selected by the scan signal may receive a data signal from a data line (one of DL1 to DLm) connected to the pixels PX. The pixels PX supplied with the data signal may generate light of a luminance (e.g., predetermined luminance) in response to a voltage of the data signal.

The data driver 120 may receive the output data Dout and the data-driving signal DCS from the timing controller 140. The data driver 120 may generate a data signal based on the data-driving signal DCS and the output data Dout. For example, the data driver 120 may generate an analog data signal based on the grayscale of the output data Dout. The data driver 120 may supply a data signal in units of one (1) horizontal period.

The scan driver 130 may receive the scan-driving signal SCS from the timing controller 140.

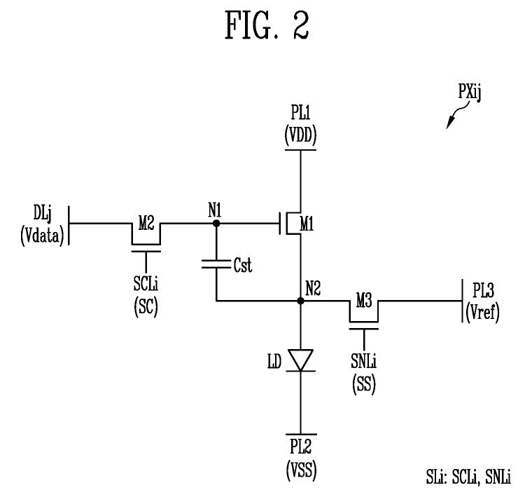

In one or more embodiments, each of the scan lines SL1 to SLn may include a scan line SCL and an initialization line SNL as shown in FIG. 2. The scan driver 130 may sequentially supply a scan signal to the scan lines SCL in response to the scan-driving signal SCS. The scan driver 130 may sequentially supply an initialization signal to the initialization lines SNL in response to the scan-driving signal SCS.

In one or more embodiments, the scan driver 130 may be arranged on the display device by a separate integrated circuit (IC). In one or more embodiments, the scan driver 130 may be formed together with the pixels PX when the pixel 110 is formed.

In one or more embodiments of the present disclosure, the display device may include a planar display device, a curved display device in which the pixel 110 is partially bent, a flexible display device, which is partially foldable or bendable, and a stretchable display device, which is partially stretchable and contractible.

In one or more embodiments of the present disclosure, the display device is for displaying a moving image or a still image, and may include a portable electronic device such as a mobile phone, a smart phone, a tablet personal computer (PC), a smart watch, a watch phone, a mobile communication terminal, an electronic notebook, an electronic book, a Portable Multimedia Player (PMP), navigation, an Ultra Mobile PC (UMPC), and the like. In one or more embodiments of the present disclosure, the display device may include an electronic device such as a television, a notebook, a monitor, a billboard, or the Internet of Things (IoT).

FIG. 2 is a circuit diagram illustrating one or more embodiments of the pixel shown in FIG. 1. In FIG. 2, for convenience of description, a pixel PXij located on an i-th horizontal line (where i is a natural number equal to or less than n and equal to or greater than 1) and a j-th vertical line (where j is a natural number less than or equal to m) are shown.

Referring to FIG. 2, the pixel PXij according to one or more embodiments of the present disclosure may include a light-emitting element LD and a pixel circuit for controlling an amount of current supplied to the light-emitting element LD. An i-th scan line SLi may include an i-th scan line SCLi and an i-th initialization line SNLi.

A first electrode (or an anode electrode) of the light-emitting element LD is connected to a first power line PL1 via a second node N2 and a first transistor M1, and a second electrode (or a cathode electrode) may be connected to a second power line PL2. The light-emitting element LD may generate light of a luminance (e.g., predetermined luminance) corresponding to the amount of current supplied from the first transistor M1.

A first driving power VDD may be supplied to the first power line PL1, and a second driving power VSS may be supplied to the second power line PL2. During a period in which the pixel PXij emits light, the first driving power VDD may have a higher voltage value than the second driving power VSS.

An organic light-emitting diode may be selected as the light-emitting element LD. In addition, the light-emitting element LD may also be selected from inorganic light-emitting diodes, such as micro LEDs and quantum dot light-emitting diodes. In addition, the light-emitting element LD may include a composite of an organic material and an inorganic material. Although FIG. 2 shows that the pixel PX comprises a single light-emitting element LD, in other embodiments, the pixel PX may include a plurality of light-emitting devices, which may be connected in series, in parallel, or in series-parallel with each other.

The pixel circuit may include the first transistor M1, a second transistor M2, a third transistor M3, and a storage capacitor Cst.

A first electrode of the first transistor M1 may be connected to the first power line PL1, and a second electrode thereof may be connected to the second node N2. The term ‘connected’ used herein may cover the meaning of being electrically connected. A gate electrode of the first transistor M1 may be connected to a first node N1. The first transistor M1 may control the amount of current supplied from the first power supply line PL1 to the second power supply line PL2 via the light-emitting element LD in response to a voltage of the first node N1.

The second transistor M2 may be connected between a j-th data line DLj and the first node N1. A gate electrode of the second transistor M2 may be electrically connected to the i-th scan line SCLi. The second transistor M2 may be turned on when an enable scan signal SC is supplied to the i-th scan line SCLi to electrically connect the j-th data line DLj and the first node N1. When the second transistor M2 is turned on, a data signal from the j-th data line DLj may be supplied to the first node N1.

The scan signal SC may have a gate on voltage (e.g., enable signal) or a gate off voltage (e.g., disable signal). The enable scan signal SC may mean that the gate on voltage is supplied to the i-th scan line SCLi, and the disable scan signal SC may mean that the gate off voltage is supplied to i-th scan lines SCLi.

The third transistor M3 may be connected between the second node N2 and a third power line PL3. A gate electrode of the third transistor M3 may be electrically connected to the i-th initialization line SNLi. This third transistor M3 may be turned on when an enable initialization signal SS is supplied to the i-th initialization line SNLi to electrically connect the second node N2 and the third power supply line PL3. When the third transistor M3 is turned on, a voltage of a reference power Vref from the third power supply line PL3 may be supplied to the second node N2.

The reference power Vref may be supplied to the third power line PL3. The voltage of the reference power Vref may be set such that the light-emitting element LD may be turned off when the voltage is supplied to the second node N2. Thus, a voltage difference between the reference power Vref and the second driving power VSS may be smaller than a threshold voltage of the light-emitting element LD. For example, the voltage of the reference power Vref may be set to a voltage that is the same as or similar to the voltage of the second driving power VSS.

The initialization signal SS may have a gate on voltage (e.g., enable) or a gate off voltage (e.g., disable). The enable initialization signal SS may mean that the gate on voltage is supplied to the i-th initialization line SNLi, and the disable initialization signal SS may mean that the gate off voltage is supplied to i-th initialization line SNLi.

Although FIG. 2 illustrates that the first to third transistors M1 to M3 are N-type transistors, embodiments of the present disclosure are not limited thereto. For example, at least one of the first to third transistors M1 to M3 may be P-type transistors.

The storage capacitor Cst may be connected between the first node N1 and the second node N2. The storage capacitor Cst may store a voltage corresponding to the data signal. For example, the storage capacitor Cst may store a voltage corresponding to a difference between the data signal supplied to the first node N1 and the reference power Vref supplied to the second node N2.

Additionally, the structure of the pixel PXij is not limited to the one or more embodiments corresponding to FIG. 2. For example, the pixel PXij may be various types of circuits.

In a brief description of the operation process, the enable scan signal SC and the enable initialization signal SS may be sequentially supplied to each of the scan lines SL1 to SLn during a driving period. The enable scan signal SC supplied to the i-th scan line SCLi may be supplied to be synchronized with the enable initialization signal SS supplied to the i-th initialization line SNLi.

When the enable initialization signal SS is supplied to the i-th initialization line SNLi, the third transistor M3 may be turned on, and the voltage of the reference power Vref may be supplied to the second node N2. When the enable scan signal SC is supplied to the i-th scan line SCLi, the second transistor M2 may be turned on, and a data signal may be supplied to the first node N1. A voltage corresponding to a difference between the data signal and the reference power Vref may be stored in the storage capacitor Cst.

The second transistor M2 may be turned off by the disable scan signal SC supplied to the i-th scan line SCLi, and the third transistor M3 may be turned on by the disable initialization signal SS supplied to the i-th initialization line SNLi. The first transistor M1 supplies a driving current (e.g., predetermined driving current) to the light-emitting element LD in response to a voltage stored in the storage capacitor Cst, and the light-emitting element LD may generate light having a luminance corresponding to the driving current.

During a sensing period, the enable scan signal SC and the enable initialization signal SS may be supplied to at least one of the scan lines SL1 to SLn so as to be synchronized with the enable scan signal SS. A scan line (at least one of SL1 to SLn) to which the enable scan signal SC and the enable initialization signal SS are supplied during a sensing period may be randomly set per sensing period.

In one or more embodiments, during the sensing period, the enable initialization signal SS may be supplied to the i-th initialization line SNLi, and the enable scan signal SC may be supplied to the i-th scan line SCLi. When the enable initialization signal SS is supplied to the i-th initialization line SNLi, the third transistor M3 may be turned on, and the voltage of the reference power Vref may be supplied to the second node N2.

When the enable scan signal SC is supplied to the i-th scan line SCLi, the second transistor M2 may be turned on, and a reference data signal (e.g., preset reference data signal) may be supplied to the first node N1. The reference data signal may have a voltage (e.g., preset voltage) for sensing the characteristics of the pixels PX. A voltage corresponding to a difference between the reference data signal and the reference power Vref may be stored in the storage capacitor Cst.

The second transistor M2 may be turned off by the disable scan signal SC supplied to the i-th scan line SCLi. The third transistor M3 is maintained in the turned-on state, and the third power line PL3 may be electrically connected to the timing controller 140 (at this time, the voltage of the reference power Vref is not supplied to the third power linePL3).

The current supplied from the first transistor M1 corresponding to the reference data signal may be supplied to the timing controller 140 via the second node N2 and the third transistor M3. The timing controller 140 may control the output data Dout to compensate for the threshold voltage, the mobility, and/or the degradation of the light-emitting element LD of the first transistor M1 in response to the current (or the voltage) from the second node N1.

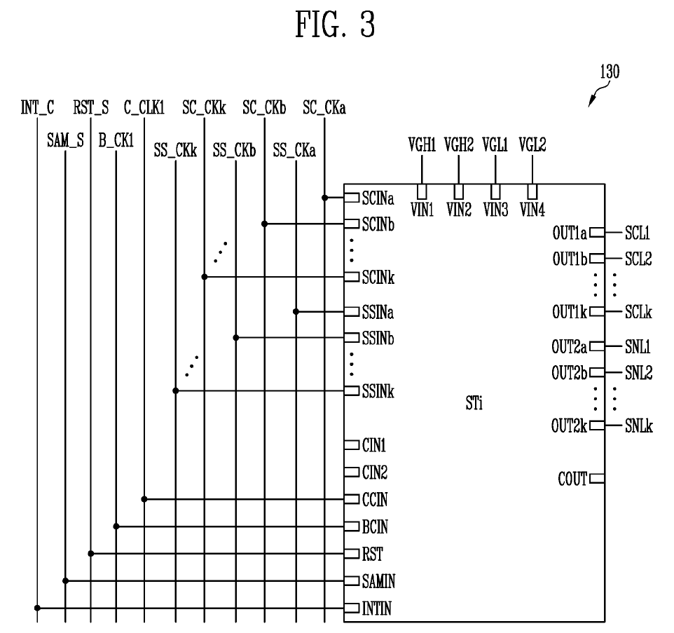

FIG. 3 is a diagram illustrating one or more embodiments of the scan driver 130 shown in FIG. 1. The scan driver 130 includes a plurality of stage circuits, and FIG. 3 illustrates an i-th stage circuit STi for convenience of description. For example, the i-th stage circuit STi may be a first stage circuit.

Referring to FIG. 3, the i-th stage circuit STi may be connected to a plurality of scan lines SCL1, SCL2, ..., and SCLk (where k is a natural number of 2 or more), and a plurality of initialization lines SNL1, SNL2, ..., and SNLk.

In one or more embodiments, the i-th stage circuit STi may be connected to k scan lines SCL1 to SCLk and supply a scan signal to the k scan lines SCL1 to SCLk. The i-th stage circuit STi may be connected to k initialization lines SNL1 to SNLk and supply an initialization signal to the k initialization lines SNL1 to SNLk. That is, the plurality of scan lines SCL1 to SCLk and the plurality of initialization lines SNL1 to SNLk may be driven by using one stage circuit, so that the mounting area of the scan driver 130 may be minimized or reduced.

In one or more embodiments, the i-th stage circuit STi may include first output terminals OUT1a, OUT1b, ..., and OUT1k and second output terminals OUT2a, OUT2b, …, OUT2k.

Each of the first output terminals OUT1a to OUT1k may be electrically connected to one of the scan lines SCL1 to SCLk. Each of the first output terminals OUT1a to OUT1k may supply an enable scan signal, which is input from the i-th stage circuit STi, to a scan line (one of SCL1 to SCLk) connected thereto.

Each of the second output terminals OUT2a to OUT2k may be electrically connected to one of the initialization lines SNL1 to SNLk. Each of the second output terminals OUT2a to OUT2k may supply an enable initialization signal, which is input from the i-th stage circuit STi, to an initialization line (one of SNL1 to SNLk) connected thereto.

In one or more embodiments, the i-th stage circuit STi may include power input terminals VIN1, VIN2, VIN3, and VIN4, scan clock input terminals SCINa, SCINb, ..., and SCINk, initialization clock input terminals SSINa, SSINb, ..., and SSINk, carry input terminals CIN1 and CIN2, a carry clock input terminal CCIN, a boosting clock input terminal BCIN, a reset input terminal RST, a sampling input terminal SAMIN, an initialization terminal INTIN, and a carry output terminal COUT.

The first power input terminal VIN1 may receive a voltage of a first power VGH1. The first power VGH1 may have a positive voltage (e.g., a logic high level voltage). The logic high level voltage may mean a voltage level at which a transistor supplied with the first power VGH1 is turned on. For example, the first power VGH1 may have a voltage of about 25 V.

The second power input terminal VIN2 may receive a voltage of the second power VGH2. The second power VGH2 may have a positive voltage, for example, a logic high level voltage or a logic low level voltage. The logic low level voltage may refer to a voltage level at which a transistor supplied with the corresponding voltage is turned off. A transistor having a gate electrode to which the second power VGH2 is supplied the may be turned on or off based on a voltage of a first electrode (or a second electrode) of the transistor. In one or more embodiments, the second power VGH2 has a lower voltage than the first power VGH1 and may have a voltage of, for example, about 15 V.

The third power input terminal VIN3 may receive a voltage of a third power VGL1. The third power VGL1 is a negative voltage and may have a logic low level voltage. The third power VGL1 has a lower voltage than the second power VGH2 and may have a voltage of for example, about −9 V.

The fourth power input terminal VIN4 may receive a voltage of a fourth power VGL2. The fourth power VGL2 is a negative voltage and may have a logic low level voltage. The fourth power VGL2 may have a lower voltage than the second power VGH2 and a higher voltage than the third power VGL1. The fourth power VGL2 may have a voltage of, for example, about −5 V.

Each of the scan clock input terminals SCINa to SCINk may receive one of scan clock signals SC_CKa, SC_CKb, ..., and SC_CKk. The scan clock signals SC_CKa to SC_CKk may be supplied to one of the first output terminals OUT1a to OUT1k, and the scan clock signals SC_CKa to SC_CKk supplied to the first output terminals OUT1a to OUT1k may be supplied as the enable scan signal SC to the scan lines SCL1 to SCLk.

Each of the initialization clock input terminals SSINa to SSINk may receive one of initialization signal SS_CKa, SS_CKb, ..., and SS_CKk. The initialization clock signals SS_CKa to SS_CKk may be supplied to one of the second output terminals OUT2a to OUT2k, and the initialization clock signals SS_CKa to SS_CKk supplied to the second output terminals OUT2a to OUT2k may be supplied as the enable initialization signal SS to the initialization lines SNL1 to SNLk.

In one or more embodiments, scan clock signals (e.g., SC_CKa to SC_CKk) and initialization clock signals (e.g., SS_CKa to SS_CKk) supplied to an odd-numbered stage circuit may be different from scan clock signals and initialization clock signals supplied to an even-numbered stage circuit. For example, scan clock signals and initialization clock signals having a phase difference (e.g., predetermined phase difference) may be supplied to the odd-numbered and even-numbered stage circuits. However, the present disclosure is not limited thereto, and for example, at least some of the scan clock signals and at least some of the initialization clock signals supplied to the odd-numbered-stage circuit and the even-numbered-phase circuit may be shared.

The carry input terminals CIN1 and CIN2 may receive carry signals from the previous stage circuit and the next stage circuit. In one or more embodiments, the first carry input terminal CIN1 may receive an (i-1)-th carry signal from the previous stage circuit, and the second carry input terminal CIN2 may receive an (i+1)-th carry signal from a next stage circuit.

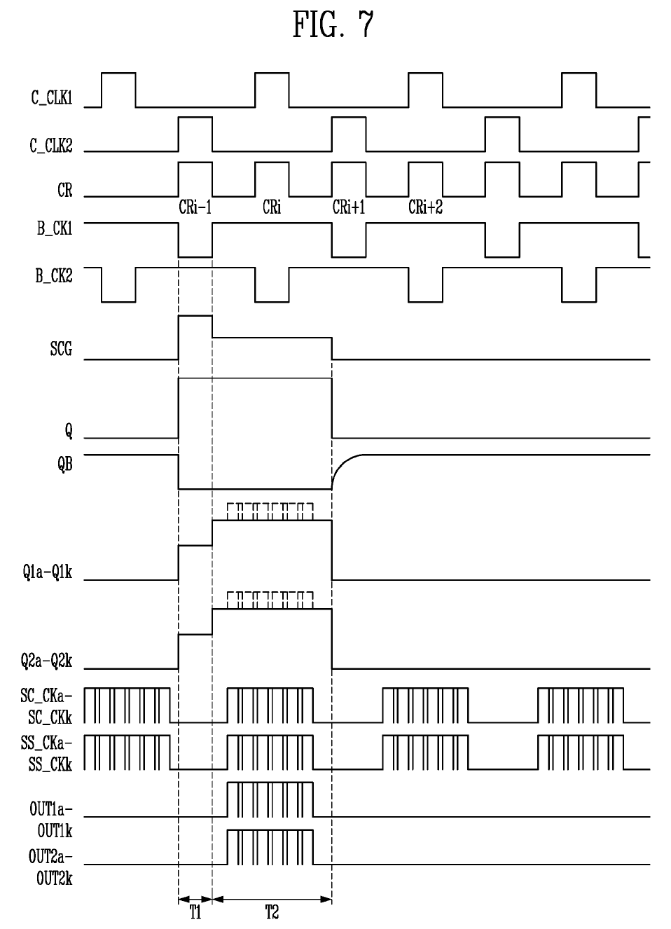

The carry clock input terminal CCIN may receive a first carry clock signal C_CLK1. For example, the carry clock input terminal CCIN included in the odd-numbered stage circuit may receive the first carry clock signal C_CLK1, and the carry clock output terminal CCIN included in the even- numbered stage circuit may receive a second carry clock signal C_CLK2 (see FIG. 7). The first and second carry clock signals C_CLK1 and C_CLK2 may have the same period and different phases as shown in FIG. 7. For example, the first and second carry clock signals C_CLK1 and C_CLK2 may have a phase difference of 180 degrees.

The boosting clock input terminal BCIN may receive a first boosting clock signal B_CK1. For example, the boosting clock input terminal BCIN included in the odd-numbered stage circuit may receive the first boosting clock signal B_CK1, and the boosting clock output terminal BCIN included in the even-numbered stage circuit may receive the second boosting clock signal (see FIG. 7). The first boosting clock signal B_CK1 and the second boosting clock signal B_CK2 may have the same period and different phases as shown in FIG. 7. For example, the first boosting clock signal B_CK1 and the second boosting clock signal B_CK2 may have a phase difference of 180 degrees.

The reset input terminal RST may receive a reset signal RST_S. The reset signal RST_S may be commonly supplied to all stage circuits, and may be used to reset the stage circuits.

The sampling input terminal SAMIN may receive a sampling signal SAM_S. The sampling signal SAM_S is supplied during the driving period, and may be for selecting a stage circuit (or a scan line and an initialization line) to which the scan signal SC and the initialization signal SS are to be supplied during the sensing period.

The initialization terminal INTIN may receive an initialization control signal INT_C. The initialization control signal INT_C is supplied during the sensing period, and may enable the scan signal SC and the initialization signal SS to be supplied to the stage circuit selected by the sampling signal SAM_S.

The sampling signal SAM_S and the initialization control signal INT_C may be global signals commonly supplied to all stage circuits. When the sampling signal SAM_S or the initialization control signal INT_C is supplied, all the stage circuits may receive the sampling signal SAM_S or the initialization control signal INT_C.

The carry output terminal COUT may output a carry signal. The carry output terminal COUT included in the i-th stage circuit STi may output an i-th carry signal.

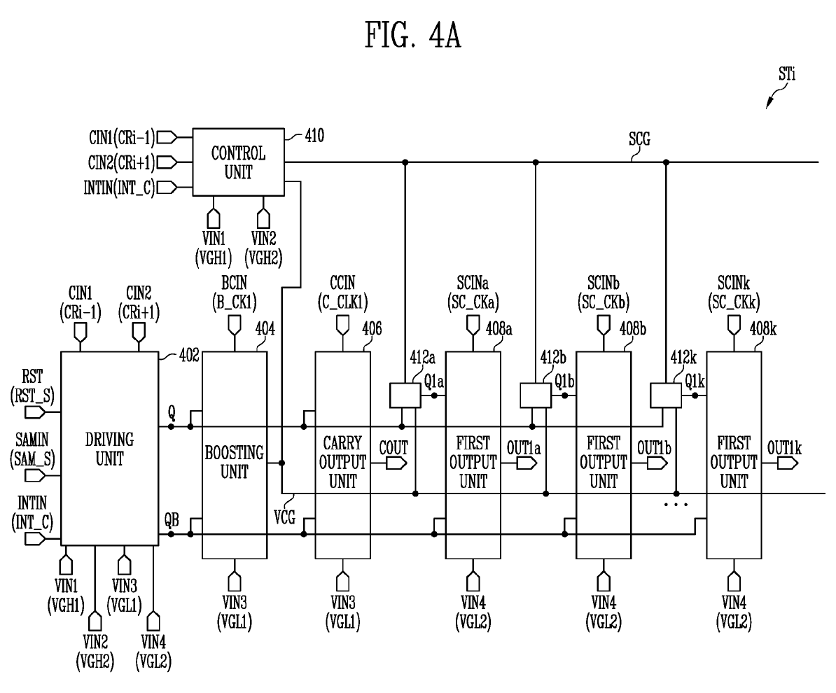

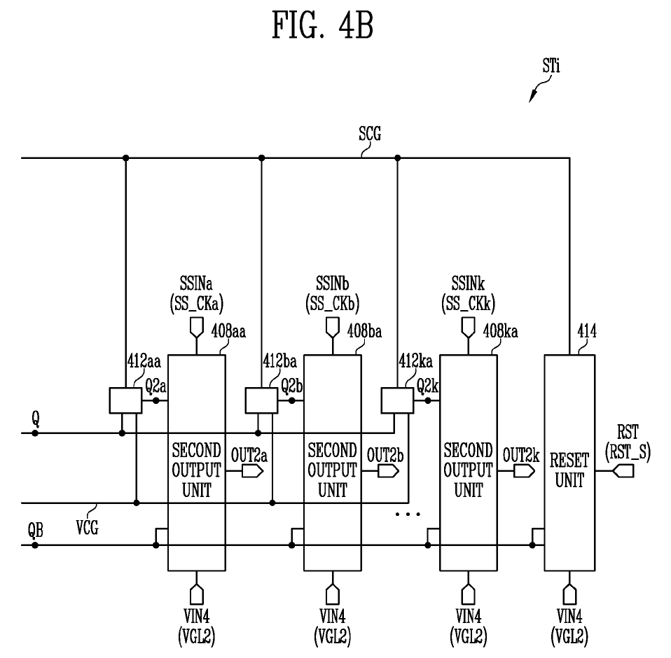

FIGS. 4A and 4B are block diagrams of the i-th stage circuit STi as shown in FIG. 3 according to one or more embodiments of the present disclosure.

Referring to FIGS. 4A and 4B, the i-th stage circuit STi according to one or more embodiments of the present disclosure may include a driver (e.g., driving unit) 402, a booster (e.g., boosting unit) 404, a carry output (e.g., carry output) 406, first outputs (e.g., first output units) 408a, 408b, ..., and 408k, first connectors (e.g., first connecting units) 412a, 412b, …, and 412k, second outputs (e.g., second output units) 408aa, 408ba, …, and 408ka, second connectors (e.g., second connecting units) 412aa, 412ba, …, and 412ka, and a reset (e.g., reset unit) 414.

The driver 402 may be connected to the first power input terminal VIN1, to the second power input terminal VIN2, to the third power input terminal VIN3, to the fourth power input terminal VIN4, to the first carry input terminal CIN1, to the second carry input terminal CIN2, to the reset input terminal RST, to the sampling input terminal SAMIN, and to the initialization terminal INTIN.

The driver 402 may control voltages of a first node Q and a second node QB. The first node Q and/or the second node QB may be electrically connected to the booster 404, to the carry output 406, to the first outputs 408a to 408k, to the first connectors 412a to 412k, to the second outputs 408aa to 408ka, to the second connectors 412aa to 412ka, and to the reset 414.

The carry output 406 may be connected to the carry clock input terminal CCIN, to the third power input terminal VIN3, and to the carry output terminal COUT. The carry output 406 may output a carry signal to the carry output terminal COUT in response to the voltages of the first node Q and the second node QB.

The booster 404 may be connected to the boosting clock input terminal BCIN, the third power input terminal VIN3, and a voltage control line VCG. The booster 404 may output a boosting signal to the voltage control line VCG in response to the voltages of the first node Q and the second node QB. The voltage control line VCG may be electrically connected to the first connectors 412a to 412k and the second connectors 412aa to 412ka.

Each of the first outputs 408a to 408k may be connected to one of the scan clock input terminals SCINa to SCINk, to one of the first output terminals OUT1a to OUT1k, and to the fourth power input terminal VIN4. Each of the first outputs 408a to 408k may be connected to the first node Q via one of first local nodes Q1a, Q1b, ..., and Q1k and one of the first connectors 412a to 412k. The first outputs 408a to 408k may supply the enable scan signal SC to the first output terminals OUT1a to OUT1k based on voltages of the first local nodes Q1a to Q1k (or the first node Q).

Each of the first connectors 412a to 412k may be connected between the first node Q and one of the first local nodes Q1a to Q1k. The first connectors 412a to 412k may electrically connect the first node Q and the first local nodes Q1a to Q1k during a first period T1 (see FIG. 7) of a period in which the first node Q has a first level (e.g., a high level voltage) and may electrically disconnect the first node Q from the first local nodes Q1a to Q1k during a second period T2 (see FIG. 7) of a period in which the first node Q has the first level.

The second period T2 may be a period during which the enable scan signal SC is output from the first outputs 408a to 408k. The first connectors 412a to 412k may electrically block the first node Q and the first local nodes Q1a to Q1k during the period in which the enable scan signal SC is output from the first outputs 408a to 408k, and thus, brightness variation in units of horizontal lines may be reduced or prevented.

For example, the voltage of the first node Q may be changed when the first node Q and the first local nodes Q1a to Q1k are electrically connected during the second period T2 in which the enable scan signal SC is output from the first outputs 408a to 408k. For example, the voltage of the first node Q may be changed based on the supply order of the enable scan signals SC and whether the enable scan signals SC overlap.

When the voltage of the first node Q is changed, the voltages of the first local nodes Q1a to Q1k may be changed. When the voltages of the first local nodes Q1a to Q1k are changed during the second period T2, the first outputs 408a to 408k may output the enable scan signals SC having different voltages, and thus, a luminance difference may be generated in units of horizontal lines.

The first outputs 408a to 408k and the first node Q are electrically cut off during the second period T2 in which the enable scan signal SC is output by using the first connectors 412a to 412k, so that a luminance difference in units of horizontal lines may be reduced or prevented.

For example, a voltage of the first local node Q1a may be changed when the enable scan signal SC is output from the first output 408a, a voltage of the first local node Q1b may be changed when the enable scan signal SC is output from the first output 408b, and a voltage of the first local node Q1k may be changed when the enable scan signal SC is output from the first output 408k. The voltage change amount of the first local nodes Q1a to Q1k may be substantially the same, so that the first outputs 408a to 408k may output the enable scan signal SC having substantially the same voltage.

Each of second outputs 408aa to 408ka may be connected to one of the initialization clock input terminals SSINa to SSINk, one of the second output terminals OUT2a to OUT2k, and the fourth power input terminal VIN4. Each of the second outputs 408aa to 408ka may be connected to the first node Q via one of the second local nodes Q2a, Q2b, ..., and Q2k, or one of the second connectors 412aa to 412ka. The second outputs 408aa to 408ka may supply the enable initialization signal SS to the second output terminals OUT2a to OUT2k based on the voltages of the second local nodes Q2a to Q2k (or the first node Q).

Each of the second connectors 412aa to 412ka may be connected between the first node Q and one of the second local nodes Q2a to Q2k. The second connectors 412aa to 412ka may electrically connect the first node Q and the second local nodes Q2a to Q2k during the first period T1 (see FIG. 7) of the period in which the first node Q has a first level (e.g., a high level voltage), and may electrically disconnect the first node Q from the second local nodes Q2a to Q2k during the second period T2 (see FIG. 7) of the period in which the first node Q has the first level.

The second period T2 may be a period in which the enable initialization signal SS is output from the second outputs 408aa to 408ka. The second connectors 412aa to 412ka may electrically block the first node Q and the second local nodes Q2a to Q2k during the period in which the enable initialization signal SS is output from the second outputs 408aa to 408ka, and thus, brightness variation in units of horizontal lines may be reduced or prevented.

For example, when the first node Q and the second local nodes Q2a to Q2k are electrically connected during the second period T2 in which the enable initialization signal SS is output from the second outputs 408aa to 408ka, the voltage of the first node Q may be changed. For example, the voltage of the first node Q may be changed based on the supply order of the enable initialization signals SS and whether the enable initialization signals SS overlap.

When the voltage of the first node Q is changed, the voltages of the second local nodes Q2a to Q2k may be changed. When the voltages of the second local nodes Q2a to Q2k are changed during the second period T2, the enable initialization signals SS having different voltages may be output from the second outputs 408aa to 408ka, and thus, a luminance difference may be generated in units of horizontal lines.

The second connectors 412aa to 412ka are used to electrically block the second outputs 408aa to 408ka and the first node Q during the second period T2 in which the enable initialization signal SS is output, thereby reducing or preventing a luminance difference in units of horizontal lines.

For example, a voltage of the second local node Q2a may be changed when the enable initialization signal SS is output from the second output 408aa, a voltage of the second local node Q2b may be changed when the enable initialization signal SS is output from the second output 408ba, and a voltage of the second local node Q2k may be changed when the enable initialization signal SS is output from the first output 408ka. The voltage change amounts of the second local nodes Q2a to Q2k may be substantially the same, so that the second outputs 408aa to 408ka may output the enable initialization signal SS having substantially the same voltage.

A controller (e.g., control unit) 410 may be connected to the first connectors 412a to 412k and the second connectors 412aa to 412ka through a connection control line SCG. The controller 410 may be connected to the first carry input terminal CIN1, to the second carry input terminal CIN2, to the initialization terminal INTIN, to the first power input terminal VIN1, and to the second power input terminal VIN2. The controller 410 may control a voltage of the connection control line SCG based on carry signals CRi-1 and CRi+1, which are input to the first carry input terminal CIN1 and the second carry input terminal CIN2. In addition, the controller 410 may control a voltage of the connection control line SCG based on the initialization control signal INT_C, which is input to the initialization terminal INTIN.

The first connectors 412a to 412k may control the electrical connections between the first local nodes Q1a to Q1k and the first node Q in response to the voltage of the connection control line SCG. As an example, the first connectors 412a to 412k may electrically connect the first local nodes Q1a to Q1k and the first node Q when the connection control line SCG has a logic high level voltage, and may electrically disconnect the first local nodes Q1a to Q2k and the first nodes Q when the connection control line SCG has a logic low level voltage.

The second connectors 412aa to 412ka may control the electrical connections between the second local nodes Q2a to Q2k and the first node Q in response to the voltage of the connection control line SCG. As an example, the second connectors 412aa to 412ka may electrically connect the second local nodes Q2a to Q2k and the first node Q when the connection control line SCG has a logic high level voltage, and may electrically disconnect the second local nodes Q2a to Q2k and the first node Q when the connection control line SCG has a logic low level voltage.

The reset 414 may be connected to the connection control line SCG, the fourth power input terminal VIN4, and the reset input terminal RST. The reset 414 may control the electrical connection between the connection control line SCG and the fourth power input terminal VIN4 based on a voltage of the second node QB. The reset 414 may control the electrical connection between the connection control line SCG and the fourth power input terminal VIN4 based on the reset signal RST_S, which is input to the reset input terminal RST.

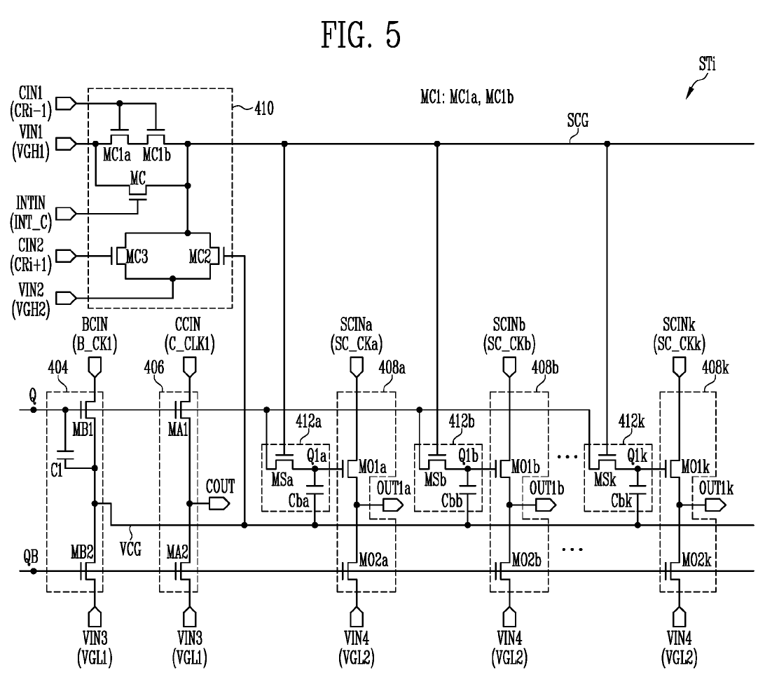

FIG. 5 is a circuit diagram showing one or more embodiments of the controller 410, the booster 404, the carry output 406, the first outputs 408a to 408k, and the connectors shown in FIG. 4A.

Referring to FIG. 5, the booster 404 may electrically connect the voltage control line VCG to the boosting clock input terminal BCIN or the third power input terminal VIN3 in response to the voltages of the first node Q and the second node QB. It may be described that a boosting signal is output when the first boosting clock signal B_CK1 is supplied to the voltage control line VCG. The boosting signal supplied to the voltage control line VCG may boost the voltages of the first node Q, the first local nodes Q1a to Q1k, and the second local nodes Q2a to Q2k.

The booster 404 may include a first boosting transistor MB1, a second boosting transistor MB2, and a first capacitor C1.

The first boosting transistor MB1 is connected between the boosting clock input terminal BCIN and the voltage control line VCG, and a gate electrode thereof may be connected to the first node Q. The first boosting transistor MB1 may control the electrical connection between the boosting clock input terminal BCIN and the voltage control line VCG based on the voltage of the first node Q.

The second boosting transistor MB2 is connected between the voltage control line VCG and the third power input terminal VIN3, and a gate electrode thereof may be connected to the second node QB. The second boosting transistor MB2 may control the electrical connection between the voltage control line VCG and the third power input terminal VIN3 in response to the voltage of the second node QB.

The carry output 406 may electrically connect the carry output terminal COUT to the carry clock input terminal CCIN or the third power input terminal VIN3 in response to the voltages of the first node Q and the second node QB. It may be described that when the first carry clock signal C_CLK1 is output to the carry output terminal COUT, a carry signal (e.g., the i-th carry signal) is output.

The carry output 406 may include a first carry transistor MA1 and a second carry transistor MA2.

The first carry transistor MA1 is connected between the carry clock input terminal CCIN and the carry output terminal COUT, and a gate electrode thereof may be connected to the first node Q. The first carry transistor MA1 may control the electrical connection between the carry clock input terminal CCIN and the carry output terminal COUT in response to the voltage of the first node Q.

The second carry transistor MA2 is connected between the carry output terminal COUT and the third power input terminal VIN3, and a gate electrode thereof may be connected to the second node QB. The second carry transistor MA2 may control the electrical connection between the carry output terminal COUT and the third power input terminal VIN3 in response to the voltage of the second node QB.

Each of the first outputs 408a to 408k may be connected to one of the scan clock input terminals SCINa to SCINk, one of the first output terminals OUT1a to OUT1k, and the fourth power input terminal VIN4. Each of the first outputs 408a to 408k may include one of first output transistors MO1a, MO1b, ..., and MO1k, and one of the second output transistors MO2a, MO2b, …, and MO2k.

A gate electrode of each of the first output transistors MO1a to MO1k may be connected to one of the first local nodes Q1a to Q1k. A gate electrode of each of the second output transistors MO2a to MO2k may be electrically connected to the second node QB.

In one or more embodiments, the first output 408a may electrically connect the first output terminal OUT1a to the scan clock input terminal SCINa or the fourth power input terminal VIN4 in response to the voltages of the first local node Q1a and the second node QB. It may be described that the enable scan signal SC is output when the scan clock signal SC_CKa is supplied to the first output terminal OUT1a. The enable scan signal SC supplied to the first output terminal OUT1a may be supplied to a scan line (e.g., SCL1) connected thereto. The first output 408a may include the first output transistor MO1a and the second output transistor MO2a.

The first output transistor MO1a is connected between the scan clock input terminal SCINa and the first output terminal OUT1a. A gate electrode of the first output transistor MO1a may be connected to the first connector 412a through the first local node Q1a. The first output transistor MO1a may control the electrical connection between the scan clock input terminal SCINa and the first output terminal OUT1a in response to the voltage of the first local node Q1a.

The second output transistor MO2a is connected between the first output terminal OUT1a and the fourth power input terminal VIN4, and a gate electrode thereof may be connected to the second node QB. The second output transistor MO2a may control the electrical connection between the first output terminal OUT1a and the fourth power input terminal VIN4 in response to the voltage of the second node QB.

In one or more embodiments, the first output 408b may electrically connect the first output terminal OUT1b to the scan clock input terminal SCINb or the fourth power input terminal VIN4 in response to voltages of the first local node Q1b and the second node QB. The first output 408b may include the first output transistor MO1b and the second output transistor MO2b.

The first output transistor MO1b is connected between the scan clock input terminal SCINb and the first output terminal OUT1b. A gate electrode of the first output transistor MO1b may be connected to the first connector 412b via the first local node Q1b. The first output transistor MO1b may control the electrical connection between the scan clock input terminal SCINb and the first output terminal OUT1b in response to the voltage of the first local node Q1b.

The second output transistor MO2b is connected between the first output terminal OUT1b and the fourth power input terminal VIN4, and a gate electrode thereof may be connected to the second node QB. The second output transistor MO2b may control the electrical connection between the first output terminal OUT1b and the fourth power input terminal VIN4 in response to the voltage of the second node QB.

In one or more embodiments, the first output 408k may electrically connect the first output terminal OUT1k to the scan clock input terminal SCINk or the fourth power input terminal VIN4 in response to voltages of the first local node Q1k and the second node QB. The first output 408k may include the first output transistor MO1k and the second output transistor MO2k.

The first output transistor MO1k is connected between the scan clock input terminal SCINk and the first output terminal OUT1k. A gate electrode of the first output transistor MO1k may be connected to the first connector 412k via the first local node Q1k. The first output transistor MO1k may control the electrical connection between the scan clock input terminal SCINk and the first output terminal OUT1k in response to the voltage of the first local node Q1k.

The second output transistor MO2k is connected between the first output terminal OUT1k and the fourth power input terminal VIN4, and a gate electrode thereof may be connected to the second node QB. The second output transistor MO2k may control the electrical connection between the first output terminal OUT1k and the fourth power input terminal VIN4 in response to the voltage of the second node QB.

Each of the first connectors 412a to 412k may be connected between the first node Q and one of the first local nodes Q1a to Q1k. The first connectors 412a to 412k may control the electrical connections between the first node Q and the first local nodes Q1a to Q1k in response to the voltage of the connection control line SCG. Each of the first connectors 412a to 412k may include one of switching transistors MSa, MSb, ..., and MSk and one of boosting capacitors Cba, Cbb, ..., and Cbk.

Each of the switching transistors MSa to MSk may be connected between the first node Q and one of the first local nodes Q1a to Q1k. A gate electrode of each of the switching transistors MSa to MSk may be connected to the connection control line SCG. The switching transistors MSa to MSk may control the electrical connections between the first node Q and the first local nodes Q1a to Q1k, respectively, based on the voltage of the connection control line SCG.

Each of the boosting capacitors Cba to Cbk may be connected between one of the first local nodes Q1a to Q1k and the voltage control line VCG. The boosting capacitors Cba to Cbk may control the voltages of the first local nodes Q1a to Q1k, respectively, in response to the voltage of the voltage control line VCG.

The controller 410 may control the voltage of the connection control line SCG in response to the carry signals CRi-1 and CRi+1, which are input to the first and second carry input terminals CIN1 and CIN2. In addition, the controller 410 may control the voltage of the connection control line SCG in response to the initialization control signal INT_C, which is input to the initialization terminal INTIN.

The controller 410 may include a control transistor MC, a first control transistor MC1, a second control transistor MC2, and a third control transistor MC3.

The control transistor MC is connected between the first power input terminal VIN1 and the connection control line SCG, and a gate electrode thereof may be connected to the initialization terminal INTIN. The control transistor MC may be turned on when the initialization control signal INT_C is input to the initialization terminal INTIN to supply the voltage of the first power VGH1 to the connection control line SCG.

The first control transistor MC1 is connected between the first power input terminal VIN1 and the connection control line SCG, and a gate electrode thereof may be connected to the first carry input terminal CIN1. The first control transistor MC1 may be turned on when the previous-stage carry signal CRi-1 (for example, the first carry signal CRI-1) is input to the first carry input terminal CIN1 to supply the voltage of the first power VGH1 to the connection control line SCG. The first control transistor MC1 may be configured by connecting a plurality of transistors MC1a and MC1b in series so as to reduce leakage current.

The second control transistor MC2 is connected between the second power input terminal VIN2 and the connection control line SCG, and a gate electrode thereof may be connected to the voltage control line VCG. The second control transistor MC2 may supply the voltage of the second power VGH2 to the connection control line SCG while being turned on or off in response to the voltage of the voltage control line VCG.

The third control transistor MC3 is connected between the second power input terminal VIN2 and the connection control line SCG, and a gate electrode thereof may be connected to the second carry input terminal CIN2. The third control transistor MC3 may be turned on when the next-stage carry signal CRi+1 (for example, the second carry signal CRi+1) is input to the second carry input terminal CIN2 to supply the voltage of the second power VGH2 to the connection control line SCG.

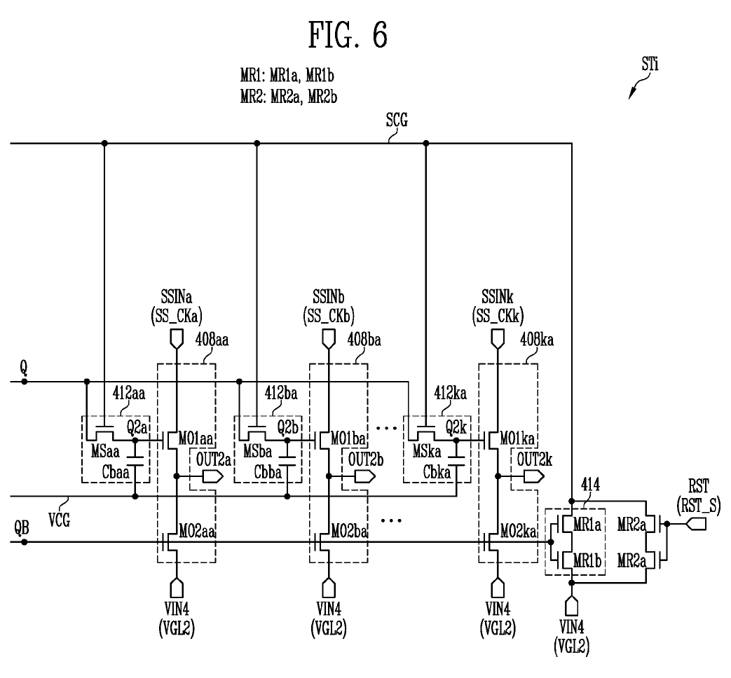

FIG. 6 is a circuit diagram illustrating one or more embodiments of the second outputs, connectors, and the reset shown in FIG. 4B.

Referring to FIG. 6, each of the second outputs 408aa to 408ka may be connected to one of the initialization clock input terminals SSINa to SSINk, one of the second output terminals OUT2a, OUT2b, ..., and OUT2k, and the fourth power input terminal VIN4. Each of the second outputs 408aa to 408ka may include one of first output transistors MO1aa, MO1ba, ..., and MO1ka, and one of second output transistors MO2aa, MO2ba, ..., and MO2ka.

A gate electrode of each of the first output transistors MO1aa to MO1ka may be connected to one of the second local nodes Q2a to Q2k. The gate electrode of each of the second output transistors MO2aa to MO2ka may be electrically connected to the second node QB.

In one or more embodiments, the second output 408aa may electrically connect the second output terminal OUT2a to the initialization clock input terminal SSINa or the fourth power input terminal VIN4 in response to voltages of the second local node Q2a and the second node QB. It may be described that the enable initialization signal SS is output when the initialization clock signal SS_CKa is supplied to the second output terminal OUT2a. The enable initialization signal SS supplied to the second output terminal OUT2a may be supplied to an initialization line (for example, SNL1) connected thereto. The second output 408aa may include the first output transistor MO1aa and the second output transistor MO2aa.

The first output transistor MO1aa is connected between the initialization clock input terminal SSINa and the second output terminal OUT2a. A gate electrode of the first output transistor MO1aa may be connected to the second connector 412aa via the second local node Q2a. The first output transistor MO1aa may control the electrical connection between the initialization clock input terminal SSINa and the second output terminal OUT2a in response to the voltage of the second local node Q2a.

The second output transistor MO2aa is connected between the second output terminal OUT2a and the fourth power input terminal VIN4, and a gate electrode thereof may be connected to the second node QB. The second output transistor MO2aa may control the electrical connection between the second output terminal OUT2a and the fourth power input terminal VIN4 in response to the voltage of the second node QB.

In one or more embodiments, the second output 408ba may electrically connect the second output terminal OUT2b to the initialization clock input terminal SSINb or the fourth power input terminal VIN4 in response to the voltages of the second local node Q2b and the second node QB. The second output 408ba may include the first output transistor MO1ba and the second output transistor MO2ba.

The first output transistor MO1ba is connected between the initialization clock input terminal SSINb and the second output terminal OUT2b. A gate electrode of the first output transistor MO1ba may be connected to the second connector 412ba via the second local node Q2b. The first output transistor MO1ba may control the electrical connection between the initialization clock input terminal SSINb and the second output terminal OUT2b in response to the voltage of the second local node Q2b.

The second output transistor MO2ba is connected between the second output terminal OUT2b and the fourth power input terminal VIN4, and a gate electrode thereof may be connected to the second node QB. The second output transistor MO2ba may control the electrical connection between the second output terminal OUT2b and the fourth power input terminal VIN4 in response to the voltage of the second node QB.

In one or more embodiments, the second output 408ka may electrically connect the second output terminal OUT2k to the initialization clock input terminal SSINk or the fourth power input terminal VIN4 in response to voltages of the second local node Q2k and the second node QB. The second output 408ka may include the first output transistor MO1ka and the second output transistor MO2ka.

The first output transistor MO1ka is connected between the initialization clock input terminal SSINk and the second output terminal OUT2k. A gate electrode of the first output transistor MO1ka may be connected to the second connector 412ka via the second local node Q2k. The first output transistor MO1ka may control the electrical connection between the initialization clock input terminal SSINk and the second output terminal OUT2k in response to the voltage of the second local node Q2k.

The second output transistor MO2ka is connected between the second output terminal OUT2k and the fourth power input terminal VIN4, and a gate electrode thereof may be connected to the second node QB. The second output transistor MO2ka may control the electrical connection between the second output terminal OUT2k and the fourth power input terminal VIN4 in response to the voltage of the second node QB.

Each of the second connectors 412aa to 412ka may be connected between the first node Q and one of the second local nodes Q2a to Q2k. The second connectors 412aa to 412ka may control the electrical connection between the first node Q and the second local nodes Q2a to Q2k in response to the voltage of the connection control line SCG. Each of the second connectors 412aa to 412ka may include one of switching transistors MSaa, MSba, ..., and MSka and one of boosting capacitors Cbaa, Cbba, …, and Cbka.

Each of the switching transistors MSaa to MSka may be connected between the first node Q and one of the second local nodes Q2a to Q2k. A gate electrode of each of the switching transistors MSaa to MSka may be connected to the connection control line SCG. The switching transistors MSaa to MSka may control the electrical connection between the first node Q and the second local nodes Q2a to Q2k, respectively, based on the voltage of the connection control line SCG.

Each of the boosting capacitors Cbaa to Cbka may be connected between one of the second local nodes Q2a to Q2k and the voltage control line VCG. The boosting capacitors Cbaa to Cbka may control the voltages of the second local nodes Q2a to Q2k, respectively, in response to the voltage of the voltage control line VCG.

The reset 414 may control the electrical connection between the fourth power input terminal VIN4 and the connection control line SCG based on the voltage of the second node QB. The reset 414 may control the electrical connection between the fourth power input terminal VIN4 and the connection control line SCG based on the reset signal RST_S, which is input to the reset input terminal RST. The reset 414 may include a first reset transistor MR1 and a second reset transistor MR2.

The first reset transistor MR1 is connected between the fourth power input terminal VIN4 and the connection control line SCG, and a gate electrode thereof may be connected to the second node QB. The first reset transistor MR1 may control the electrical connection between the fourth power input terminal VIN4 and the connection control line SCG in response to the voltage of the second node QB. The first reset transistor MR1 may be configured by connecting a plurality of transistors MR1a and MR1b in series.

The second reset transistor MR2 is connected between the fourth power input terminal VIN4 and the connection control line SCG, and a gate electrode thereof may be connected to the reset input terminal RST. The second reset transistor MR2 may be turned on when the reset signal RST_S is input to the reset input terminal RST to supply the voltage of the fourth power VGL2 to the connection control line SCG. The second reset transistor MR2 may be configured by connecting a plurality of transistors MR2a and MR2b in series.

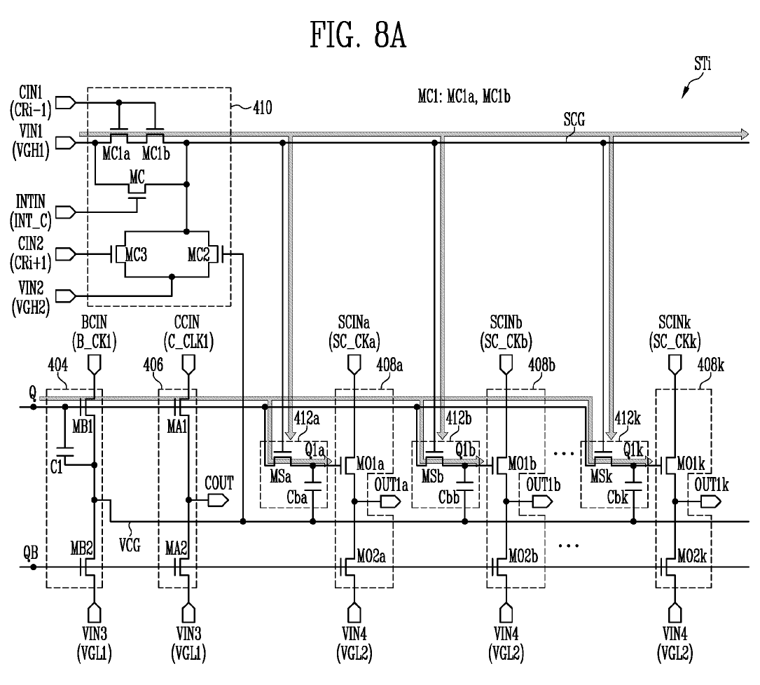

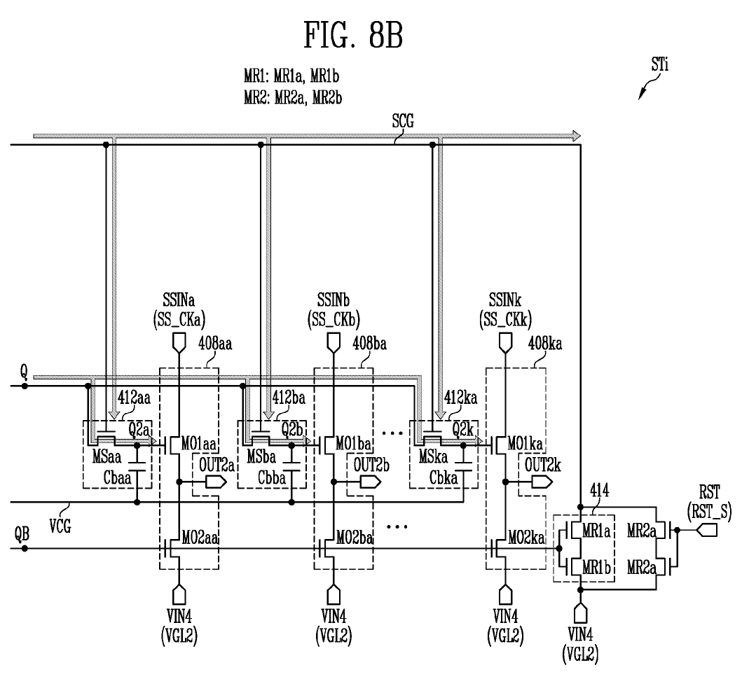

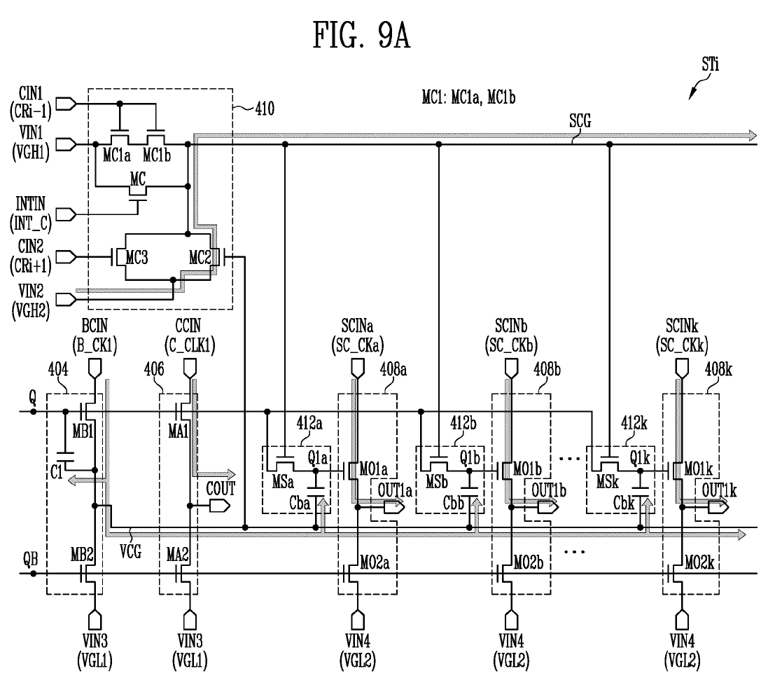

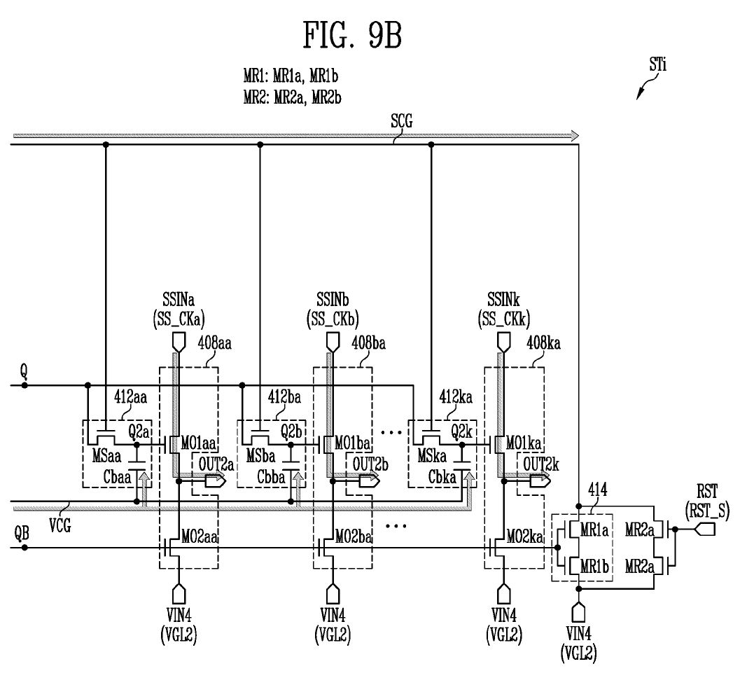

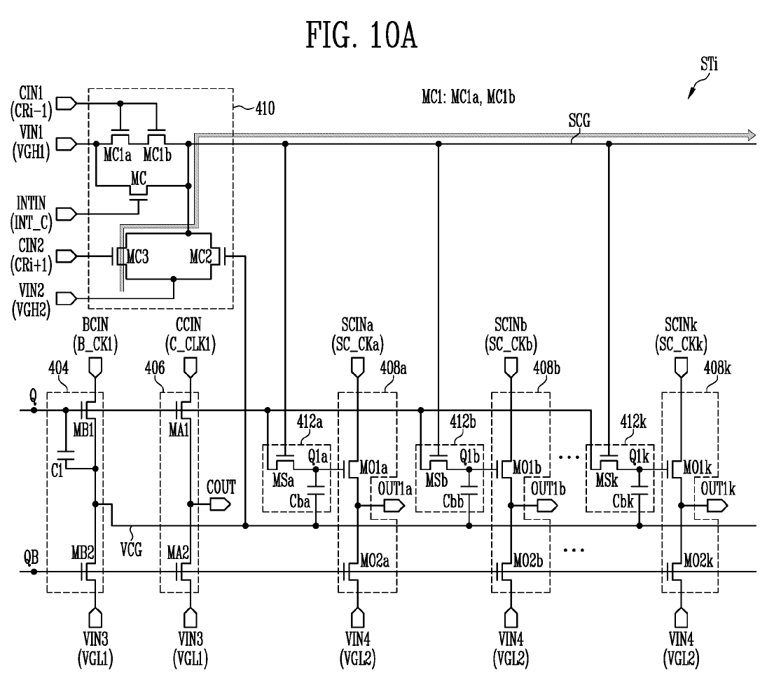

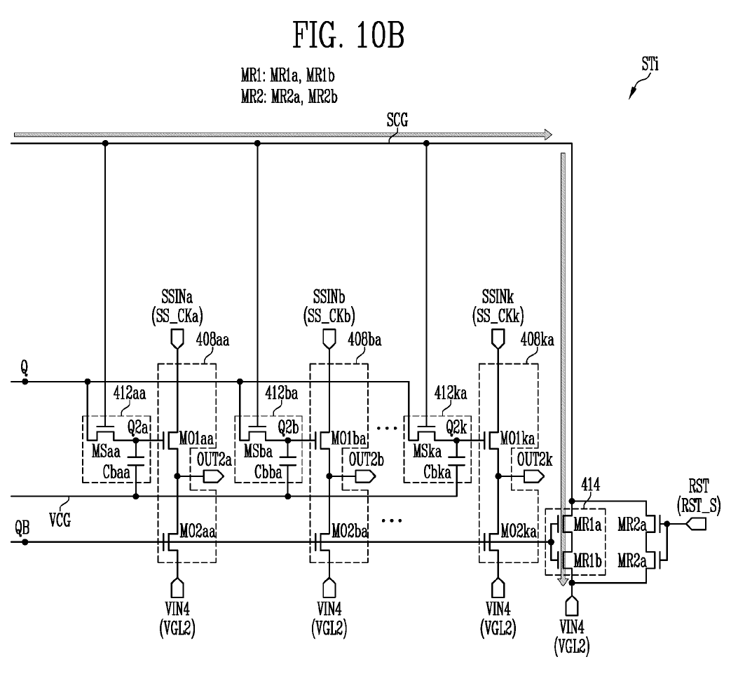

FIG. 7 is a waveform diagram showing one or more embodiments of the method of driving the stage circuit as shown in FIGS. 5 and 6. FIGS. 8A, 8B, 9A, 9B, 10A and 10B are diagrams illustrating an operation process of a stage circuit corresponding to the driving waveform of FIG. 7.

The part indicated by SC_CKa-SC_CKk in FIG. 7 may mean the scan clock signals SC_CKa to SC_CKk. Although some of the scan clock signals SC_CKa to SC_CKk are shown to overlap, the present disclosure is not limited thereto. For example, the scan clock signals SC_CKa to SC_CKk may be supplied so as not to overlap.

The part indicated by SS_CKa-SS_CKk in FIG. 7 may mean initialization clock signals SS_CKa to SS_CKk. Although some of the initialization clock signals SS_CKa to SS_CKk are shown to overlap, the present disclosure is not limited thereto. For example, the initialization clock signals SS_CKa to SS_CKk may be supplied so as not to overlap.

Referring to FIG. 7, the first and second carry clock signals C_CLK1 and C_CLK2 may have the same period and a phase difference of 180 degrees. The first boosting clock signal B_CK1 and the second boosting clock signal B_CK2 have the same period and a phase difference of 180 degrees. The carry clock signals C_CLK1 and C_CLK2 and the boosting clock signals B_CK1 and B_CK2 may have the same period.

A high voltage (e.g., a logic high level voltage) of the carry clock signals C_CLK1 and C_CLK2 during one period may be supplied for a shorter time than a low voltage (e.g., a logic low level voltage). A low voltage (e.g., a logic low level voltage) of the boosting clock signals B_CK1 and B_CK2 during one period may be supplied for a shorter time than a high voltage (e.g., a logic high level voltage).

The low voltage of the first boosting clock signal B_CK1 may at least partially overlap with a low voltage of the first carry clock signal C_CLK1, and a high voltage thereof may at least partially overlap with a high voltage of the first carry clock signal C_CLK1. The low voltage of the first boosting clock signal B_CK1 may at least partially overlap with the high voltage of the second carry clock signal C_CLK2, and the high voltage thereof may at least partially overlap with the low voltage of the second carry clock signal C_CLK2.

The carry signal (CR: CRi-1, CRi, CRi+1, CRi+2, ...) may be set to a high voltage (e.g., a logic high level voltage) and may be synchronized with the high voltages of the carry clock signals C_CLK1 and C_CLK2. As an example, the stage circuits may output the high voltage of the carry clock signals C_CLK1 and C_CLK2 to the carry signal (CR: CRi-1, CRi, CRi+1, CRi+2, ...).

Referring to FIGS. 5 to 7, 8A and 8B, the first carry signal CRi-1 (e.g., a logic high level) may be input to the first carry input terminal CIN1 during the first period T1. When the first carry signal CRi-1 is input to the first carry input terminal CIN1, the driver 402 may supply the voltage of the first power VGH1 (for example, a high voltage) to the first node Q and a voltage of the third power VGL1 (for example, a low voltage) to the second node QB. The detailed operation process of the driver 402 will be described below.

When a high voltage is supplied to the first node Q, the first boosting transistor MB1 and the first carry transistor MA1 may be turned on. When the first boosting transistor MB1 is turned on, the boosting clock input terminal BCIN may be electrically connected to the voltage control line VCG. When the first carry transistor MA1 is turned on, the carry clock input terminal CCIN may be electrically connected to the carry output terminal COUT.

When the first carry signal CRi-1 is input to the first carry input terminal CIN1, the first control transistor MC1 may be turned on. When the first control transistor MC1 is turned on, the voltage of the first power VGH1 may be supplied to the connection control line SCG. When a high voltage (for example, the voltage of the first power VGH1) is supplied to the connection control line SCG, the switching transistors MSa to MSk and MSaa to MSka may be turned on. When the switching transistors MSa to MSk and MSaa to MSka are turned on, a high voltage of the first node Q may be supplied to the local nodes Q1a to Q1k and Q2a to Q2k. When a high voltage is supplied to the local nodes Q1a to Q1k and Q2a to Q2k, the first output transistors MO1a to MO1k and MO1aa to MO1ka may be turned on.

Referring to FIGS. 5 to 7, 9A and 9B, the high-level first carry clock signal C_CLK1 may be input to the carry clock input terminal CCIN during the second period T2. The high-level first carry clock signal C_CLK1, which is input to the carry clock input terminal CCIN, may be supplied to the carry output terminal COUT via the first carry transistor MA1. The high-level first carry clock signal C_CLK1, which is output to the carry output terminal COUT, may be supplied as the i-th carry signal CRi to the next stage and/or the previous stage circuit.

During the second period T2, the high-level first boosting clock signal B_CK1 may be input to the boosting clock input terminal BCIN. The high-level first boosting clock signal B_CK1 may be supplied as a boosting signal to the voltage control line VCG via the first boosting transistor MB1. Thus, the voltage control line VCG may be raised from the low voltage to the high voltage by a boosting signal.

When the voltage of the voltage control line VCG is increased by the boosting signal, the voltage of the first node Q may be increased by the first capacitor C1. For example, the voltage of the first node Q may be raised to a voltage approximately twice as high as that of the first power VGH1.

When the voltage of the voltage control line VCG is raised by the boosting signal, the voltage of the local nodes Q1a to Q1k and Q2a to Q2k may be raised by the boost capacitors Cba to Cbk and Cbaa to Cbka. For example, the local nodes Q1a to Q1k and Q2a to Q2k may be raised to a voltage approximately twice as high as the first power VGH1. When the voltage of the local nodes Q1a to Q1k and Q2a to Q2k is raised to a voltage higher than the first power VGH1, the first output transistors MO1a to MO1k and MO1aa to MO1ka may be stably maintained in a turn-on state for the second period T2.

When the voltage of the voltage control line VCG is raised by the boosting signal, the second control transistor MC2 may be turned on. When the second control transistor MC2 is turned on, a voltage of the second power VGH2 may be supplied to the connection control line SCG. The voltage of the second power VGH2 supplied to the connection control line SCG may be supplied to gate electrodes of the switching transistors MSa to MSk and MSaa to MSka.

A first electrode and a second electrode of each of the switching transistors MSa to MSk and MSaa to MSka are set to a voltage, which is higher than that of the first power VGH1. Therefore, when the gate electrode of each of the switching transistors MSa to MSk and MSaa to MSka is supplied with the voltage of the second power VGH2 lower than the first power VGH1, the switching transistors MSA to MSk and MSaa to MSka may be turned off.

The high-level scan clock signals SC_CKa to SC_CKk may be input to the scan clock input terminals SCINa to SCINk during the second period T2. Because the first output transistors MO1a to MO1k maintain the turn-on state, the high-level scan clock signals SC_CKa to SC_CKk may be supplied as the enable scan signal SC to the first output terminals OUT1a to OUT1k.

The high-level initialization clock signals SS_CKa to SS_CKk may be input to the initialization clock input terminals SSINa to SSINk during the second period T2. Because the first output transistors MO1aa to MO1ka maintain the turn-on state, the high-level initialization clock signals SS_CKa to SS_CKk may be supplied as the enable initialization signal SS to the second output terminals OUT2a to OUT2k.

During the second period T2 in which the enable scan signal SC and the enable initialization signal SS are output to the output terminals OUT1a to OUT1k and OUT2a to OUT2k, the switching transistors MSa to MSk and MSaa to MSka remain in a turn-off state, and thus, an image having a substantially uniform luminance may be displayed in the pixel 110.

In other words, when the switching transistors MSa to MSk and MSaa to MSka are not provided, voltages of the first node Q and the local nodes Q1a to Q1k and Q2a to Q2k may be changed by a parasitic capacitor of the first output transistors MO1a to MO1k and MO1aa to MO1ka during the second period T2 in which the enable scan signal SC and the enable initialization signal SS are output. For example, the voltage of the first node Q may be changed in response to the supply order of the enable scan signal SC and the enable initialization signal SS, so that a luminance difference may be generated in units of horizontal lines.

On the other hand, when the local nodes Q1a to Q1k and Q2a to Q2k and the first node Q are electrically cut off by the switching transistors MSa to MSk and MSaa to MSka, the first node Q may maintain a constant voltage. In addition, the local nodes Q1a to Q1k and Q2a to Q2k may be changed to substantially the same voltage by outputting the enable scan signal SC or the enable initialization signal SS, thereby reducing or preventing the luminance difference from occurring in units of horizontal lines.

The switching transistors MSa to MSk and MSaa to MSka may be turned off by using the voltage of the second power VGH2, which is a positive voltage during the second period T2. A voltage difference Vgs between the switching transistors MSa to MSk and MSaa to MSka may be kept low, and thus, the stress of the switching transistors MSA to MSk and MSaa to MSka is reduced or minimized to ensure driving stability.

Referring to FIGS. 5 to 7, 10A and 10B, the second carry signal CRi+1 may be input to the second carry input terminal CIN2 after the second period T2. When the second carry signal CRi+1 is input to the second carry input terminal CIN2, a voltage of the third power VGL1 (or a low voltage) may be supplied to the first node Q, and a voltage of the second power VGH2 (or a high voltage) may be provided to the second node QB. The second node QB may be raised to a high voltage by an inverter included in the driver 402, and the second node QB may be gradually raised to a high voltage by a load of circuit elements connected to the second node QB.

When the second carry signal CRi+1 is input to the second carry input terminal CIN2, the third control transistor MC3 may be turned on. When the third control transistor MC3 is turned on, the voltage of the second power VGH2 may be supplied to the connection control line SCG. The switching transistors MSa to MSk and MSaa to MSka may be turned on because the first node Q is set to the voltage of the third power VGL1. When the switching transistors MSa to MSk and MSaa to MSka are turned on, the local nodes Q1a to Q1k and Q2a to Q2k may have a low voltage.

Because the voltage of the second node QB gradually rises to a high voltage, after the local nodes Q1a to Q1k and Q2a to Q2k are set to a low voltage, the first reset transistor MR1 may be turned on. When the first reset transistor MR1 is turned on, a voltage of the fourth power VGL2 may be supplied to the connection control line SCG.

The second node QB may maintain the high voltage for at least a part of a period excluding the first period T1 and the second period T2, so that the connection control line SCG may maintain the voltage of the fourth power VGL2. When the fourth power VGL2 is supplied to the connection control line SCG, the switching transistors MSa to MSk and MSaa to MSka are turned off, so that the local nodes Q1a to Q1k and Q2a to Q2k may maintain a low voltage.

The stage circuit STi according to the above may receive the first carry signal CRi-1 as a previous-stage carry signal and the second carry signal CRi+1 as a next-stage carry signal and be driven. When the next-stage carry signal is the (i+1)-th carry signal (CRi+1), the addition of unnecessary dummy stages may be reduced or minimized.

For example, when an (i+2)-th carry signal or more are used as the next-stage carry signal, dummy stages may be additionally formed. In addition, it may be difficult to secure a sensing period when the (i+2)-th carry signal serves as the next-stage carry signal.

The stage circuit STi may control the connectors 412a to 412k and 412aa to 412ka by using one controller 410, thereby reducing or minimizing the mounting area of the stage circuit STi.

The stage circuit STi may control the connectors 412a to 412k and 412aa to 412ka and the outputs 408a to 408k and 408aa to 408ka by using the voltages of the first node Q and the second node QB, thereby reducing or minimizing the mounting area of the stage circuit STi.

FIG. 11 is a diagram showing one or more embodiments of the driver 402 as shown in FIG. 4A.

Referring to FIG. 11, the driver 402 according to one or more embodiments of the present disclosure may include an initialization controller section ICP, a reset section RES, a first driver section DVP1, a second driver section DVP2, and an inverter section INV.

The inverter section INV may control the voltage of the second node QB in response to the voltage of the first node Q. For example, when a voltage of the first node Q is a high voltage (or a low voltage), the inverter section INV may set a voltage of the second node QB to a low voltage (or a high voltage).

The inverter section INV may include a 17th transistor T17, an 18th transistor T18, a 19th transistor T19, a 20th transistor T20, and a 21st transistor T21.

The 17th transistor T17 and the 18th transistor T18 may be connected in series between the second power input terminal VIN2 and a gate electrode of the 19th transistor T19. Gate electrodes of the 17th transistor T17 and the 18th transistor T18 may be connected to the second power input terminal VIN2. The 17th transistor T17 and the 18th transistor T18 may be connected in the form of a diode so that current may flow from the second power input terminal VIN2 to the gate electrode of the 19th transistor T19.

The 20th transistor T20 may be connected between the gate electrode of the 19th transistor T19 and the fourth power input terminal VIN4. A gate electrode of the 20th transistor T20 may be connected to the first node Q.

The 21st transistor T21 may be connected between the second node QB and the third power input terminal VIN3. A gate electrode of the 21st transistor T21 may be connected to the first node Q.

The 19th transistor T19 may be connected between the second power input terminal VIN2 and the second node QB. The gate electrode of the 19th transistor T19 may be connected to a common node between the 18th transistor T18 and the 20th transistor T20.

The first driver section DVP1 may supply a high voltage to the first node Q when the first carry signal CRi-1 is input from the first carry input terminal CIN1. The first driver section DVP1 may include an 11th transistor T11, a 12th transistor T12, a 13th transistor T13, a 14th transistor T14, a 15th transistor T15, and a 16th transistor T16.

The 11th transistor T11 and the 12th transistor T12 may be connected in series between the first power input terminal VIN1 and a third node N3. Gate electrodes of the 11th transistor T11 and the 12th transistor T12 may be connected to the first node Q. The 11th transistor T11 and the 12th transistor T12 may control the electrical connection between the first power input terminal VIN1 and the third node N3 while being turned on or off in response to a voltage of the first node Q.

The 13th transistor T13 may be connected between the first carry input terminal CIN1 and the third node N3. A gate electrode of the 13th transistor T13 may be connected to the first carry input terminal CIN1. The 13th transistor T13 may be connected in the form of a diode to allow current to flow from the first carry input terminal CIN1 to the third node N3.

The 14th transistor T14 may be connected between the third node N3 and the first node Q. A gate electrode of the 14th transistor T14 may be connected to the first carry input terminal CIN1.

The 15th transistor T15 may be connected between the first node Q and the third node N3. A gate electrode of the 15th transistor T15 may be connected to the second node QB.

The 16th transistor T16 may be connected between the third node N3 and the third power input terminal VIN3. A gate electrode of the 16th transistor T16 may be connected to the second node QB.

The second driver section DVP2 may control a voltage of the first node Q based on the second carry signal CRi+1 input to the second carry input terminal CIN2. The second driver section DVP2 may include a ninth transistor T9 and a 10th transistor T10.

The ninth transistor T9 may be connected between the first node Q and the third node N3. A gate electrode of the ninth transistor T9 may be connected to the second carry input terminal CIN2.

The 10th transistor T10 may be connected between the third node N3 and the third power input terminal VIN3. A gate electrode of the 10th transistor T10 may be connected to the second carry input terminal CIN2.

The reset section RES may control a voltage of the first node Q based on the reset signal RST_S, which is input to the reset input terminal RST. The reset section RES may include a seventh transistor T7 and an eighth transistor T8.

The seventh transistor T7 may be connected between the first node Q and the third node N3. A gate electrode of the seventh transistor T7 may be connected to the reset input terminal RST.

The eighth transistor T8 may be connected between the third node N3 and the third power input terminal VIN3. A gate electrode of the eighth transistor T8 may be connected to the reset input terminal RST.

The seventh transistor T7 and the eighth transistor T8 may be turned on when the reset signal RST_S is input to supply the voltage of the third power VGL1 to the first node Q. The reset signal RST_S is supplied for initializing the stage circuit, and may be supplied, for example, after the display device is turned on.

The initialization controller section ICP may supply the enable scan signal SC to the scan line located on the corresponding horizontal line and the enable initialization signal SS to the initialization line located on the above corresponding horizontal line during the sensing period based on the sampling signal SAM_S, which is input to the sampling input terminal SAMIN and the initialization control signal INT_C, which is input to the initialization terminal INTIN. The initialization controller section ICP may include a first transistor T1, a second transistor T2, a third transistor T3, a fourth transistor T4, a fifth transistor T5, and a sixth transistor T6.

The first transistor T1 may be connected between the first power input terminal VIN1 and a fourth node N4. A gate electrode of the first transistor T1 may be connected to a fifth node N5.

The second transistor T2 and the third transistor T3 may be connected in series between the first carry input terminal CIN1 and the fifth node N5. Gate electrodes of the second transistor T2 and the third transistor T3 may be connected to the sampling input terminal SAMIN. A common node of the second transistor T2 and the third transistor T3 may be connected to the fourth node N4.

The fourth transistor T4 may be connected between the fourth node N4 and the first node Q. A gate electrode of the fourth transistor T4 may be connected to the initialization terminal INTIN.

The fifth transistor T5 and the sixth transistor T6 may be connected in series between the second node QB and the third power input terminal VIN3. A gate electrode of the fifth transistor T5 may be connected to the fifth node N5, and a gate electrode of the sixth transistor T6 may be connected to the initialization terminal INTIN.

A holding capacitor Ch may be connected between the first power input terminal VIN1 and the fifth node N5. The holding capacitor Ch may store a voltage of the fifth node N5.

It should be noted that the embodiments of the present disclosure are not limited thereto, and the configuration of the driver 402 may be composed of various circuits, which are currently known. For example, the driver 402 may be configured with various currently known circuits capable of controlling the first node Q and the second node QB.

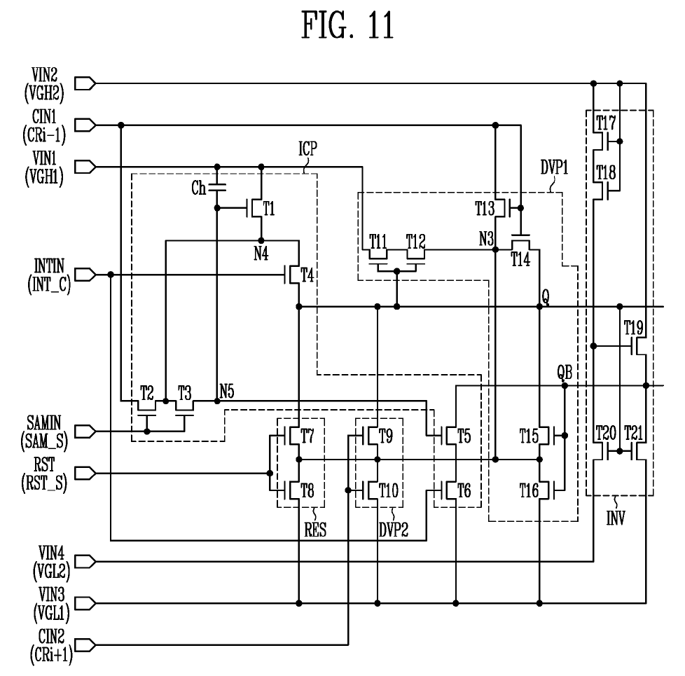

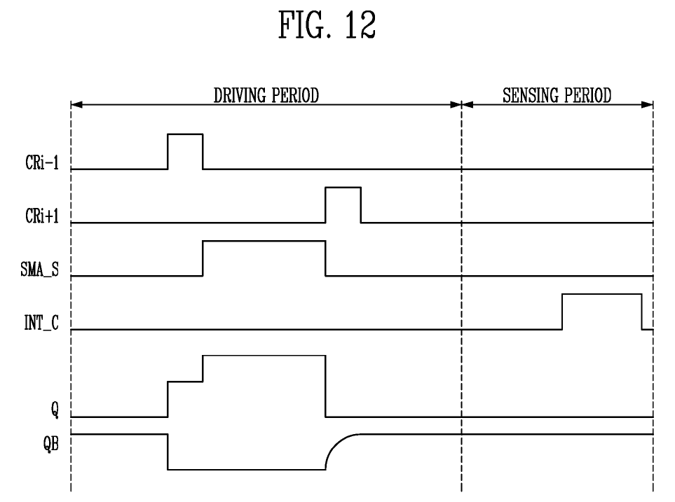

FIG. 12 is a waveform diagram showing an operation process of the driver 402 shown in FIG. 11. The part as described above with reference to FIG. 7 will be omitted or briefly described with reference to FIG. 12.

Referring to FIG. 12, the first carry signal CRi-1 may be input to the first carry input terminal CIN1 during the driving period.

When the first carry signal CRi-1 is input, the 13th transistor T13 and the 14th transistor T14 are turned on, so that the first node Q may be raised to a high voltage. When the first node Q is raised to the high voltage, the 11th transistor T11 and the 12th transistor T12 are turned on, and a voltage of the first power VGH1 may be supplied to the third node N3. The third node N3 is electrically connected to the first node Q via the 14th transistor T14, so that the first node Q may have approximately the voltage of the first power VGH1.

When the first node Q has a high voltage, the 20th transistor T20 and the 21st transistor T21 may be turned on. When the 20th transistor T20 is turned on, a voltage of the fourth power VGL2 is supplied to the gate electrode of the 19th transistor T19, and thus, the 19th transistor T19 is turned off. When the 21st transistor T21 is turned on, a voltage of the third power VGL1 is supplied to the second node QB, so that the second node QB may have a low voltage.

The sampling signal SAM_S may be input to the sampling input terminal SAMIN during the driving period. As an example, the sampling signal SAM_S may be supplied during a period in which the enable scan signal SC and the enable initialization signal SS are output at a corresponding stage. When the sampling signal SAM_S is supplied, the second transistor T2 and the third transistor T3 included in the corresponding stage circuit may be turned on.

When the second transistor T2 and the third transistor T3 are turned on, the first carry input terminal CIN1 and the fifth node N5 may be electrically connected. A voltage of the first carry signal CRi-1 input to the first carry input terminal CIN1, that is, a high voltage is supplied to the fifth node N5, and the high voltage (for example, a voltage corresponding to the turn-on of the first transistor T1) may be stored in the holding capacitor Ch.

When the sampling signal SAM_S is supplied, the second transistor T2 and the third transistor T3, which are not included in the corresponding stage circuit but are included in, for example, the remaining stage circuits, may also be turned on.

When the second transistor T2 and the third transistor T3 are turned on, the first carry input terminal CIN1 and the fifth node N5 included in each of the remaining stage circuits may be electrically connected. A carry signal is not supplied to the first carry input terminal CIN1 included in each of the remaining stage circuits, and accordingly, a voltage corresponding to the turn-off of the first transistor T1 may be stored in the holding capacitor Ch included in each of the remaining stage circuits.

The second carry signal CRi+1 may be input to the second carry input terminal CIN2. When the second carry signal CRi+1 is input, the ninth transistor T9 and the 10th transistor T10 may be turned on. When the ninth transistor T9 and the10th transistor T10 are turned on, the voltage of the third power VGL1 may be supplied to the first node Q. The first node Q may be set to a low voltage.

When the first node Q is set to a low voltage, the 20th transistor T20 and the 21st transistor T21 may be turned off. The gate electrode of the 19th transistor T19 is raised to the voltage of the second power VGH2 by the 17th transistor T17 and the 18th transistor T18 connected in the form of a diode, so that the 19th transistor T19 may be turned on. When the 19th transistor T19 is turned on, a voltage (that is, a high voltage) of the second power VGH2 may be supplied to the second node QB.

When the voltage of the second node QB is set to a high voltage, the 15th transistor T15 and the 16th transistor T16 may be turned on. When the 15th transistor T15 and the 16th transistor T16 are turned on, the voltage of the third power VGL1 is supplied to the first node Q, so that the first node Q may maintain a low voltage.

During the sensing period, the initialization control signal INT_C may be input to the initialization terminal INTIN. When the initialization control signal INT_C is input to the initialization terminal INTIN, the fourth transistor T4 and the sixth transistor T6 included in all the stage circuits may be turned on. When the initialization control signal INT_C is input to the initialization terminal INTIN, the control transistor MC included in each of the stage circuits may be turned on.

When the control transistor MC is turned on, the voltage of the first power VGH1 may be supplied to the connection control line SCG. The switching transistors MSa to MSk and MSaa to MSka connected to the connection control line SCG may be turned on. When the switching transistors MSa to MSk and MSaa to MSka are turned on, the local nodes Q1a to Q1k and Q2a to Q2k may be connected to the first node Q.

The first transistor T1 and the fifth transistor T5 included in each of the remaining stages in which the holding capacitor Ch is charged with a turn-off voltage remain in the turn-off state. Accordingly, the first node Q may maintain a low voltage, and the second node QB may maintain a high voltage.

The first transistor T1 and the fifth transistor T5 included in a corresponding stage in which the holding capacitor Ch is charged with a turn-on voltage may be turned on. Because the fourth transistor T4 is set to the turn-on state, the voltage of the first power VGH1 may be supplied to the first node Q via the first transistor T1 and the fourth transistor T4. In addition, because the sixth transistor T6 is set to the turn-on state, the voltage of the third power VGL1 may be supplied to the second node QB via the sixth transistor T6 and the fifth transistor T5.

At least one of the scan clock signals SC_CKa to SC_CKk and at least one of the initialization clock signals SS_CKa to SS_CKk may then be input to the corresponding stage. For example, one of the scan clock signals SC_CKa to SC_CKk and one of the initialization clock signals SS_CKa to SS_CKk supplied to the corresponding stage may be supplied with the enable scan signal SC of the corresponding horizontal line and the enable initialization signal SS of the corresponding horizontal line during the sensing period.

That is, the stage circuit may randomly supply the enable scan signal SC and the enable initialization signal SS to a horizontal line (e.g., predetermined horizontal line) during the sensing period while controlling the supply time of the sampling signal SAM_S. Subsequently, the reset signal RST_S or the like may be supplied to initialize the stage circuit.

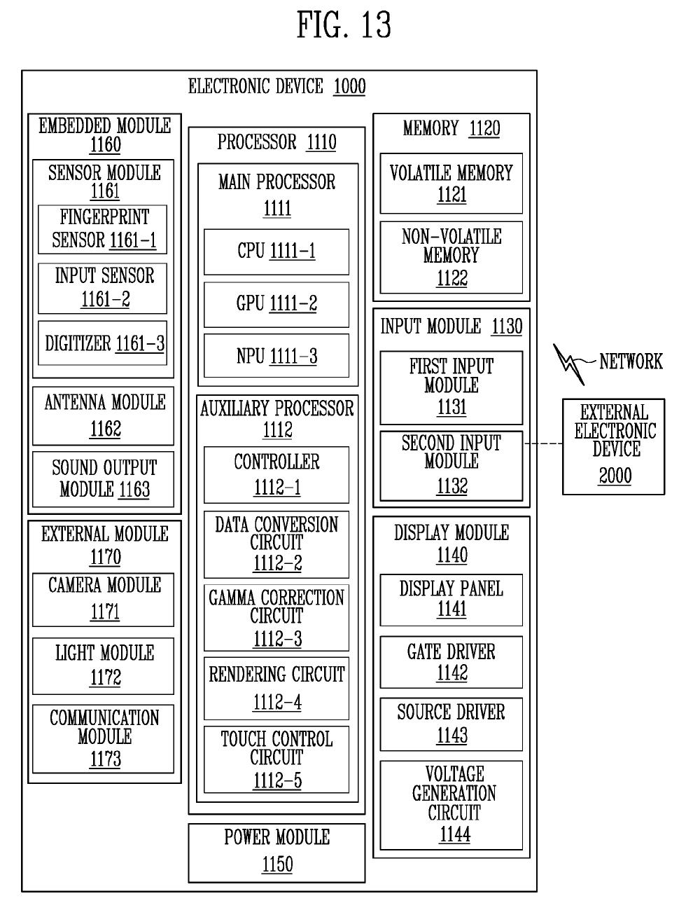

FIG. 13 is a diagram illustrating an electronic device 1000 according to one or more embodiments of the present disclosure.

Referring to FIG. 13, the electronic device 1000 according to one or more embodiments of the present disclosure outputs various types of information through a display module 1140. When a processor 1110 executes an application stored in a memory 1120, the display module 1140 provides application information to a user through a display panel 1141.

The processor 1110 obtains an external input through an input module 1130 or a sensor module 1161 and executes an application corresponding to the external input. For example, when the user selects a camera icon (or a camera application icon) displayed on the display panel 1141, the processor 1110 obtains a user input through an input sensor 1161-2 and activates a camera module 1171. The processor 1110 transmits image data corresponding to a captured image acquired through the camera module 1171 to the display module 1140. The display module 1140 may display an image corresponding to the captured image through the display panel 1141.

As another example, when personal information authentication is executed in the display module 1140, a fingerprint sensor 1161-1 acquires input fingerprint information as input data. The processor 1110 compares the input data acquired through the fingerprint sensor 1161-1 with authentication data stored in the memory 1120, and executes the application according to the comparison result. The display module 1140 may display information executed according to the logic of the application through the display panel 1141. The fingerprint sensor 1161-1 may be arranged to acquire fingerprint information in the entire area of the display module 1140 (or the display panel 1141).

As another example, when a music streaming icon displayed in the display module 1140 is selected, the processor 1110 obtains a user input through the input sensor 1161-2 and activates a music streaming application stored in the memory 1120. When a music execution command is input in the music streaming application, the processor 1110 activates a sound output module 1163 to provide sound information corresponding to the music execution command to the user.

The operation of the electronic device 1000 has been briefly described above. The configuration of the electronic device 1000 will be described in detail below. Some of the components of the electronic device 1000 to be described below may be integrated and provided as one configuration, or one configuration may be provided separately as two or more configurations.

The electronic device 1000 may communicate with an external electronic device 2000 via a network (e.g., a near field communication network or a far field communication network). According to one or more embodiments, the electronic device 1000 may include the processor 1110, the memory 1120, the input module 1130, the display module 1140, a power module 1150, an internal module 1160, and an external module 1170. According to one or more embodiments, at least one of the above-described components of the electronic device 1000 may be omitted, or one or more other components may be added. According to one or more embodiments, some of the above-described components (e.g., the sensor module 1161, an antenna module 1162, or the sound output module 1163) may be integrated into another component (e.g., the display module 1140).

The processor 1110 may execute software to control at least one other component (e.g., a hardware or software component) of the electronic device 1000 connected to the processor 1110, and may perform various data processing or operations. According to one or more embodiments, as at least part of the data processing or operation, the processor 1110 may store instructions or data received from other components (e.g., the input module 1130, the sensor module 1161, or a communication module 1173) in a volatile memory 1121, process the instructions or data stored in the volatile memory 1211, and store result data in a non-volatile memory 1122.

The processor 1110 may include a main processor 1111 and an auxiliary processor 1112. The main processor 1111 may include a central processing unit (CPU) 1111-1. The main processor 1111 may further include any one or more of a graphics processing unit (GPU) 1111-2, a communication processor (CP), and an image signal processor (ISP). The main processor 1111 may further include a neural processing unit (NPU) 1111-3. The neural processing unit 1111-3 is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more of the above, but is not limited to the foregoing examples. The artificial intelligence model may include a software structure additionally or generally in addition to a hardware structure. At least two of the foregoing processing units and processors may be implemented in a single integrated configuration (e.g., a single chip), or in separate configurations (e.g., multiple chips).

The auxiliary processor 1112 may include a controller 1112-1. The controller 1112-1 may include an interface conversion circuit and a timing control circuit. As an example, the auxiliary processor 1112 may include the timing controller 140 as shown in FIG. 1. At least some functions (or configurations) of the timing controller 140 may be included in the controller 1112-1, a data conversion circuit 1112-2, a gamma correction circuit 1112-3, a rendering circuit 1112-4, and the like.

The controller 1112-1 receives an image signal from the main processor 1111, converts a data format of the image signal to meet interface specifications with the display module 1140, and outputs image data. The controller 1112-1 may output various control signals for driving the display module 1140.

The auxiliary processor 1112 may further include the data conversion circuit 1112-2, the gamma correction circuit 1112-3, the rendering circuit 1112-4, a touch control circuit 1112-5, and the like. The data conversion circuit 1112-2 may receive the image data from the controller 1112-1, and compensate the image data so that an image may be displayed at a desired luminance according to the characteristics of the electronic device 1000 or user's settings, or convert the image data to reduce power consumption or compensate for afterimages.

The gamma correction circuit 1112-3 may convert image data, a gamma reference voltage, or the like so that the image displayed on the electronic device 1000 may have a desired gamma characteristic. The rendering circuit 1112-4 may receive the image data from the controller 1112-1 and render the image data in consideration of a pixel arrangement of the display panel 1141 applied to the electronic device 1000.

The touch control circuit 1112-5 may supply a touch signal to the input sensor 1161-2 and receive a sensing signal from the input sensor 1161-2 in response to a touch signal.

At least one of the data conversion circuit 1112-2, the gamma correction circuit 1112-3, the rendering circuit 1112-4, and the touch control circuit 1112-5 may be integrated into another component (e.g., the main processor 1111 or the controller 1112-1). At least one of the data conversion circuit 1112-2, the gamma correction circuit 1112-3, and the rendering circuit 1112-4 may be integrated into a source driver 1143 to be described below.

The memory 1120 may store various data used by at least one component of the electronic device 1000 (e.g., the processor 1110 or the sensor module 1161) and input data or output data for instructions related thereto. In addition, various setting data corresponding to the user's settings may be stored in the memory 1120. The memory 1120 may include at least one or more of the volatile memory 1121 and a non-volatile memory 1122.

The input module 1130 may receive instructions or data to be used for components of the electronic device 1000 (e.g., the processor 1110, the sensor module 1161, or the sound output module 1163) from outside the electronic device 1000, such as the user or the external electronic device 2000.

The input module 1130 may include a first input module 1131 for inputting a command or data from the user, and a second input module 1132 for inputting the command or data from the external electronic device 2000. The first input module 1131 may include a microphone, a mouse, a keyboard, a key (e.g., a button), or a pen (e.g., a passive pen or an active pen). The second input module 1132 may support a specified protocol, which may be wired or wirelessly connected to the external electronic device 2000. According to one or more embodiments, the second input module 1132 may include a high definition multimedia interface (HDMI), a universal serial bus (USB) interface, an SD card interface, or an audio interface. The second input module 1132 may include a connector, which may be physically connected to the external electronic device 2000, for example, an HDMI connector, a USB connector, an SD card connector, or an audio connector (e.g., a headphone connector).

The display module 1140 provides visual information to the user. The display module 1140 may include the display panel 1141, a gate driver 1142, the source driver 1143, and a voltage generation circuit 1144. The display module 1140 may further include a window, a chassis, and a bracket for protecting the display panel 1141. The display module 1140 may include at least some components of the display device shown in FIG. 1.

The display panel 1141 (or a display) may include a liquid crystal display panel, an organic light-emitting display panel, or an inorganic light-emitting display panel. The type of the display panel 1141 is not particularly limited. The display panel 1141 may be of a rigid type display panel or a flexible type display panel, which is rollable or foldable. The display module 1140 may further include a supporter, a bracket, a heat dissipation member, or the like, which supports the display panel 1141. The display panel 1141 may include the pixel 110 as shown in FIG. 1.

The gate driver 1142 may be mounted as a driving chip on the display panel 1141. In addition, the gate driver 1142 may be integrated into the display panel 1141. For example, the gate driver 1142 may include an Amorphous Silicon TFT Gate (ASG) driver circuit, a Low Temperature Polycrystalline Silicon (LTPS) TFT Gate driver circuit, and an Oxide Semiconductor TFT Gate (OSG) driver circuit internalized in the display panel 1141. The gate driver 1142 receives a control signal from the controller 1112-1 and outputs scan signals to the display panel 1141 in response to the control signal. The gate driver 1142 may include the scan driver 130 shown in FIG. 1. As an example, the gate driver 1142 may include the i-th stage circuit STi shown in FIG. 3. As an example, the gate driver 1142 may include the driver 402, the boosters 404, the carry output 406, the outputs 408a to 408k and 408aa to 408ka, the connectors 412a to 412k and 412aa to 412ka, the controller 410, and the reset 414 as shown in FIGS. 4A and 4B.

The display module 1140 may further include a light-emitting driver. The light-emitting driver outputs a light-emitting control signal to the display panel 1141 in response to the control signal received from the controller 1112-1. The light-emitting driver may be formed separately from the gate driver 1142, or may be integrated into the gate driver 1142.

The source driver 1143 receives a control signal from the controller 1112-1, converts the image data into an analog voltage (e.g., a data signal) in response to the control signal, and outputs data signals to the display panel 1141. The source driver 1143 may include the data driver 120 as shown in FIG. 1.

The source driver 1143 may be integrated into other components (e.g., the controller 1112-1). The functions of the interface conversion circuit and the timing control circuit of the controller 1112-1 as described above may be integrated into the source driver 1143. The voltage generation circuit 1144 may output various voltages for driving the display panel 1141.

In one or more embodiments, the source driver 1143 may convert data corresponding to red (R), green (G), and blue (B) included in the image data received from the processor 1110 into a red data signal (or a data voltage), a green data signal, and a blue data signal, and may provide the data as a plurality of pixel columns included in the display panel 1141 during one horizontal period.

The power module 1150 supplies power to the components of the electronic device 1000. The power module 1150 may include a battery, which charges a power voltage. The battery may include a non-rechargeable primary battery, a rechargeable secondary battery, or a fuel cell. The power module 1150 may include a power management integrated circuit (PMIC). The PMIC supplies optimized power to each of the modules as described above and to be described below. The power module 1150 may include a wireless power transmission/reception member electrically connected to a battery. The wireless power transmission/reception member may include a plurality of antenna radiators in the form of coils. In one or more embodiments, at least some configurations of the power module 1150 and the voltage generation circuit 1144 may be provided integrated into one. For example, the voltage generation circuit 1144 may be included in the power module 1150.

The electronic device 1000 may further include an internal module 1160 and the external module 1170. The internal module 1160 may include the sensor module 1161, the antenna module 1162, and the sound output module 1163. The external module 1170 may include the camera module 1171, a light module 1172, and the communication module 1173.

The sensor module 1161 may detect an input by a user's body or an input by a pen in the first input module 1131, and may generate an electrical signal or a data value corresponding to the input. The sensor module 1161 may include at least one or more of the fingerprint sensor 1161-1, the input sensor 1161-2, and a digitizer 1161-3.

The fingerprint sensor 1161-1 may generate a data value corresponding to the user's fingerprint.

The input sensor 1161-2 may generate a data value corresponding to coordinate information of the input by the user's body or the input by the pen. The input sensor 1161-2 generates the amount of change in capacitance due to the input as a data value. The input sensor 1161-2 may detect an input by a passive pen, or may transmit and receive data to and from an active pen.

The input sensor 1161-2 may measure a biometric signal such as blood pressure, moisture, or body fat. For example, when the user contacts a body part with a sensor layer or a sensing panel and does not move for a certain period of time, based on an electric field change caused by the body part, the input sensor 1161-2 may sense the biometric signal and output information desired by the user to the display module 1140.

The digitizer 1161-3 may generate a data value corresponding to the coordinate information of the input by the pen. The digitizer 1161-3 generates the amount of electromagnetic change by the input as a data value. The digitizer 1161-3 may sense input by the passive pen or may transmit and receive data to and from the active pen.

At least one of the fingerprint sensor 1161-1, the input sensor 1161-2, and the digitizer 1161-3 may be a sensor layer formed on the display panel 1141 through a continuous process. At least one of the fingerprint sensor 1161-1, the input sensor 1161-2, and the digitizer 1161-3 may be arranged on an upper side of the display panel 1141, and one of the fingerprint sensors 1161-1, an input sensor 1161-3, and the digitizer1161-3, for example, the digitizer 1161-3 may be arranged on a lower side of the display panel 1141.

At least two or more of the fingerprint sensor 1161-1, the input sensor 1161-2, and the digitizer 1161-3 may be integrated into one sensing panel through the same process, and the one sensing panel may be arranged between the display panel 1141 and a window arranged above the display panel 1141. According to one or more embodiments, the sensing panel may be arranged on the window, and the position of the sensing panel is not particularly limited.

At least one of the fingerprint sensor 1161-1, the input sensor 1161-2, and the digitizer 1161-3 may be embedded in the display panel 1141. That is, at least one of the fingerprint sensor 1161-1, the input sensor 1161-2, or the digitizer 1161-3 may be concurrently or substantially simultaneously formed through a process of forming elements (e.g., a light-emitting element, a transistor, or the like) included in the display panel 1141.

In addition, the sensor module 1161 may generate an electrical signal or a data value corresponding to an internal state or an external state of the electronic device 1000. The sensor module 1161 may further include, for example, a gesture sensor, a gyro sensor, an air pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas for transmitting or receiving signals or power externally. According to one or more embodiments, the communication module 1173 may transmit or receive a signal from an external electronic device through an antenna suitable for a communication method. An antenna pattern of the antenna module 1162 may be integrated into one configuration (e.g., the display panel 1141) of the display module 1140, the input sensor 1161-2, or the like.

The sound output module 1163 is a device for outputting a sound signal to the outside of the electronic device 1000, and may include, for example, a speaker used for general purposes such as multimedia playback or recording playback, and a receiver used exclusively for telephone reception. According to one or more embodiments, the receiver may be formed integrally with or separately from the speaker. The sound output pattern of the sound output module 1163 may be integrated into the display module 1140.

The camera module 1171 may capture still images and videos. According to one or more embodiments, the camera module 1171 may include one or more lenses, image sensors, or image signal processors. The camera module 1171 may further include an infrared camera capable of measuring the presence or absence of the user, the position of the user, a gaze of the user, and the like.

The light module 1172 may provide light. The light module 1172 may include a light-emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and communication through the established communication channel. The communication module 1173 may include one or both of a wireless communication module such as a cellular communication module, a near field communication module, or a global navigation satellite system (GNSS) communication module, and a wired communication module such as an area network (LAN) communication module or a power line communication module. The communication module 1173 may communicate with the external electronic device 2000 through a local area communication network such as Bluetooth Bluetooth® (Bluetooth® being a registered trademark of Bluetooth Sig, Inc., Kirkland, WA), Wi-Fi Direct^{TM} (Wi-Fi Direct^{TM} being a registered trademark of the non-profit Wi-Fi Alliance), or infrared data association (IrDA) or a remote communication network such as a cellular network, the Internet, or a computer network (e.g., LAN or WAN). The various types of communication modules 1173 described above may be implemented in one chip or separate chips.

The input module 1130, the sensor module 1161, the camera module 1171, and the like may be utilized to control the operation of the display module 1140 in conjunction with the processor 1110.

The processor 1110 outputs a command or data to the display module 1140, the sound output module 1163, the camera module 1171, or the light module 1172 based on input data received from the input module 1130. For example, the processor 1110 may generate image data in response to input data applied through a mouse, an active pen, or the like and output the image data to the display module 1140, or may generate command data in response to the input data and output the command data to the camera module 1171 or the light module 1172. When input data is not received from the input module 1130, the processor 1110 may switch the operation mode of the electronic device 1000 to a low-power mode or a sleep mode to reduce power consumed by the electronic device 1000.

The processor 1110 outputs a command or data to the display module 1140, the sound output module 1163, the camera module 1171, or the light module 1172 based on sensing data received from the sensor module 1161. For example, the processor 1110 may compare the authentication data authorized by the fingerprint sensor 1161-1 with the authentication data stored in the memory 1120, and may then execute the application according to the comparison result. The processor 1110 may execute a command or output corresponding image data to the display module 1140 based on the sensing data sensed by the input sensor 1161-2 or the digitizer 1161-3. When the sensor module 1161 includes a temperature sensor, the processor 1110 may receive temperature data for the measured temperature from the sensor module 1161, and may further perform luminance correction or the like on the image data based on the temperature data.

The processor 1110 may receive measurement data on the presence or absence of the user, the position of the user, and the gaze of the user from the camera module 1171. The processor 1110 may further correct luminance of image data based on the measurement data. For example, the processor 1110, which determines the presence or absence of the user through input from the camera module 1171 may output the image data whose luminance has been corrected to the display module 1140 through the data conversion circuit 1112-2 or the gamma correction circuit 1112-3.

Some of the above components may be connected to each other through a communication method between peripheral devices, for example, a bus, a general purpose input/output (GPIO), a serial peripheral interface (SPI), a mobile industry processor interface (MIPI), or an ultra path interconnect (UPI) link to exchange signals (e.g., commands or data) with each other. The processor 1110 may communicate with the display module 1140 through a mutually agreed interface, for example, one of the above-described communication schemes may be used, and the communication scheme is not limited thereto.

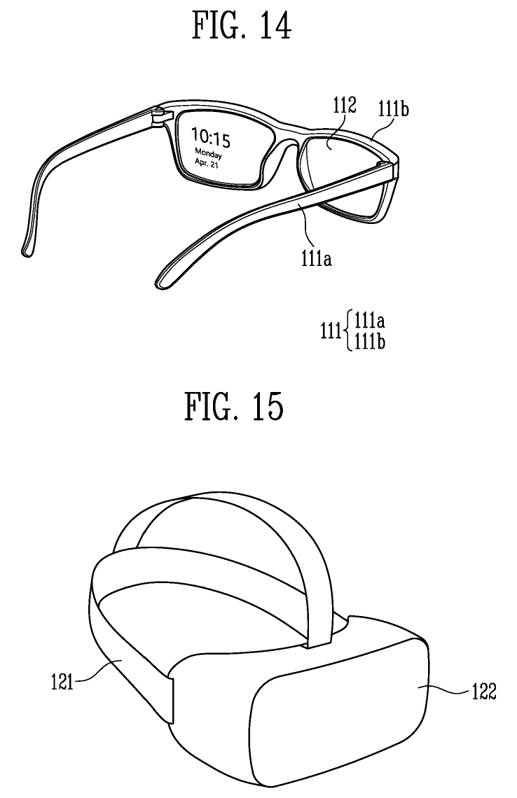

FIGS. 14 to 17 are diagrams illustrating the electronic device 1000 according to various embodiments of the present disclosure.

Referring to FIG. 14, a display device according to one or more embodiments of the present disclosure may be applied to a smart glass. The smart glass may include a frame 111 and a lens portion 112. The smart glass may be a wearable electronic device, which is worn to the face of the user. A portion of the frame 111 may be folded or unfolded. For example, the smart glass may be a wearable device for augmented reality (AR).

The frame 111 may include a housing 111b, which supports the lens portion 112 and a leg portion 111a, which allows the user to wear the smart glass. The leg portion 111a may be connected to the housing 111b by a hinge and may be folded or unfolded.

A battery, a touch pad, a microphone, and/or a camera may be embedded in the frame 111. In addition, the frame 111 may be embedded with a projector, which outputs light and/or a processor, which controls an optical signal.

The lens portion 112 may be an optical member, which transmits or reflects light. The lens portion 112 may include glass and/or a transparent synthetic resin.

The display device according to embodiments of the present disclosure may be applied to the lens portion 112. For example, the user may recognize an image, which is displayed by an optical signal, which is sent from a projector of the frame 111, through the lens portion 112. For example, the user may recognize information, such as the time and date displayed on the lens portion 112.

Referring to FIG. 15, the display device according to one or more embodiments of the present disclosure may be applied to a head-mounted display (HMD). The HMD may include a head-mounted band 121 and a display accommodating case 122. For example, the HMD may be a wearable electronic device, which is worn to the head of the user.

The head-mounted band 121 may be connected to the display accommodating case 122 to fix the display accommodating case 122. The head-mounted band 121 may include a horizontal band and a vertical band to fix the HMD to the user’s head. The horizontal band may be wound to extend along the side of the head of the user, and the vertical band may be wound to extend along the upper part of the head of the user. However, the head-mounted band 121 is not limited thereto, and the head-mounted band 121 may be a glass frame type or a helmet type.

The display accommodating case 122 may accommodate the display device and include at least one lens. At least one lens may provide the user with an image. For example, the display device may be applied to a left eye lens and a right eye lens, which are provided in the display accommodating case 122.

Referring to FIG. 16, the display device may be applied to a smartwatch. The smartwatch may include a display portion 131 and a strap portion 133. The smartwatch may be a wearable electronic device and the strap portion 133 may be worn to the wrist of the user. According to embodiments of the present disclosure, the display device may be applied to the display portion 131. For example, the display portion 131 may provide image data including information such as the time and date.

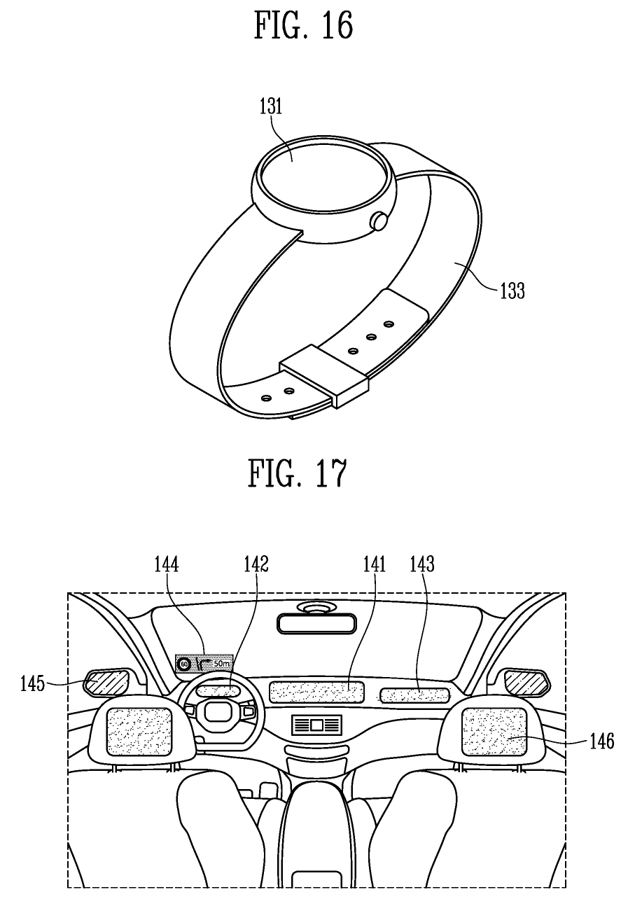

Referring to FIG. 17, the display device may be applied to an automotive display. For example, the automotive display may refer to an electronic device, which is provided on the inside and the outside of a vehicle and provides image data.

For example, the display device according to one or more embodiments of the present disclosure may be applied to at least one of an infotainment panel 141, a cluster 142, a co-driver display 143, a heads-up display 144, a side mirror display 145, or a rear seat display 146, which are provided in the vehicle.

A stage circuit, a display device including the same, and an electronic device according to embodiments of the present disclosure include one stage circuit that drives a plurality of scan lines and a plurality of initialization lines, thereby minimizing or reducing a mounting area.

A stage circuit, a display device including the same, and an electronic device according to embodiments of the present disclosure control first outputs outputting a scan signal and second outputs outputting an initialization signal by using one controller, and thus, thereby minimizing or reducing a mounting area.

The embodiments described above are provided to explain the present disclosure, but these embodiments are not intended to limit the scope of the present disclosure. It will be understood by those skilled in the art that various changes, substitutions, and alternatives may be made therein without departing from the scope of the disclosure as set forth by the claims and their equivalents. Therefore, the technical scope of the present disclosure may be determined based on the scope of the accompanying claims and their functional equivalents.

What is claimed is:

1. A stage circuit comprising:
a controller connected to a first power input terminal, to a second power input terminal, to a first carry input terminal, to a second carry input terminal, and to an initialization terminal, and configured to control a voltage of a connection control line;
a driver configured to control a voltage of a first node and a voltage of a second node;
first outputs configured to supply scan clock signals as an enable scan signal to first output terminals based on voltages of first local nodes;
second outputs configured to supply initialization clock signals as an enable initialization signal to second output terminals based on voltages of second local nodes;
first connectors configured to control electrical connections between the first node and the first local nodes based on a voltage of the connection control line; and
second connectors configured to control electrical connections between the first node and the second local nodes based on the voltage of the connection control line.

2. The stage circuit of claim 1, wherein the first connectors are configured to electrically connect the first node and the first local nodes during a first period of a period in which the first node is set to a high-level voltage, and to block the electrical connections between the first node and the first local nodes during a second period of the period in which the first node is set to the high-level voltage.

3. The stage circuit of claim 1, wherein the second connectors are configured to electrically connect the first node and the second local nodes during a first period of a period in which the first node is set to a high-level voltage, and to block the electrical connections between the first node and the second local nodes during a second period of the period in which the first node is set to the high-level voltage.

4. The stage circuit of claim 1, further comprising a carry output connected to a carry clock input terminal configured to receive a carry clock signal and to a third power input terminal, and configured to connect a carry output terminal to the carry clock input terminal or to the third power input terminal based on the voltage of the first node and the voltage of the second node.

5. The stage circuit of claim 4, wherein first power of the first power input terminal and second power of the second power input terminal are positive voltages, and wherein third power of the third power input terminal is a negative voltage.

6. The stage circuit of claim 4, wherein, when a carry signal is an i-th carry signal, an (i-1)-th carry signal is input to the first carry input terminal, and an (i+1)-th carry signal is input to the second carry input terminal.

7. The stage circuit of claim 4, wherein the carry output comprises:
a first carry transistor connected between the carry clock input terminal and the carry output terminal, and having a gate electrode connected to the first node; and
a second carry transistor connected between the carry output terminal and the third power input terminal, and having a gate electrode connected to the second node.

8. The stage circuit of claim 1, further comprising a booster connected to a boosting clock input terminal configured to receive a boosting clock and to a third power input terminal, and connecting a voltage control line to the boosting clock input terminal or to the third power input terminal based on the voltage of the first node and the voltage of the second node.

9. The stage circuit of claim 8, wherein the booster comprises:
a first boosting transistor connected between the boosting clock input terminal and the voltage control line, and having a gate electrode connected to the first node;
a second boosting transistor connected between the voltage control line and the third power input terminal, and having a gate electrode connected to the second node; and
a first capacitor connected between the first node and the voltage control line.

10. The stage circuit of claim 8, wherein the first connectors comprise:
a switching transistor connected between one of the first local nodes and the first node, and having a gate electrode connected to the connection control line; and
a boosting capacitor connected between the one of the first local nodes and the voltage control line.

11. The stage circuit of claim 8, wherein the second connectors comprise:
a switching transistor connected between one of the second local nodes and the first node, and having a gate electrode connected to the connection control line; and
a boosting capacitor connected between the one of the second local nodes and the voltage control line.

12. The stage circuit of claim 8, wherein the controller comprises:
a control transistor connected between the first power input terminal and the connection control line, and having a gate electrode connected to the initialization terminal;
a first control transistor connected between the first power input terminal and the connection control line, and having a gate electrode connected to the first carry input terminal;
a second control transistor connected between the second power input terminal and the connection control line, and having a gate electrode connected to the voltage control line; and
a third control transistor connected between the second power input terminal and the connection control line, and having a gate electrode connected to the second carry input terminal.

13. The stage circuit of claim 1, wherein the first outputs comprise:
a first output transistor connected between one of scan clock input terminals configured to receive the scan clock signals and one of the first output terminals, and having a gate electrode connected to one of the first local nodes; and
a second output transistor connected between a fourth power input terminal and the one of the first output terminals, and having a gate electrode connected to the second node.

14. The stage circuit of claim 1, wherein the second outputs comprise:
a first output transistor connected between one of initialization clock input terminals configured to receive the initialization clock signals and one of the second output terminals, and having a gate electrode connected to one of the first local nodes; and
a second output transistor connected between a fourth power input terminal and the one of the second output terminals, and having a gate electrode connected to the second node.

15. The stage circuit of claim 1, further comprising a reset connected between the connection control line and a fourth power input terminal, and configured to control a connection between the connection control line and the fourth power input terminal in response to the voltage of the second node or a reset signal of a reset input terminal.

16. The stage circuit of claim 15, wherein the reset comprises:
at least one first reset transistor connected between the connection control line and the fourth power input terminal, and having a gate electrode connected to the second node; and
at least one second reset transistor connected between the connection control line and the fourth power input terminal, and having a gate electrode connected to the reset input terminal.

17. A display device comprising:
pixels connected to scan lines, initialization lines, and data lines; and
a scan driver comprising stage circuits configured to supply a scan signal to the scan lines and an initialization signal to the initialization lines, at least one of the stage circuits comprising:
a controller connected to a first power input terminal, to a second power input terminal, to a first carry input terminal, to a second carry input terminal, and to an initialization terminal, and configured to control a voltage of a connection control line;
a driver configured to control a voltage of a first node and a voltage of a second node;
first outputs configured to supply scan clock signals as an enable scan signal to first output terminals based on voltages of first local nodes;
second outputs configured to supply initialization clock signals as an enable initialization signal to second output terminals based on voltages of second local nodes;
first connectors configured to control electrical connections between the first node and the first local nodes based on a voltage of the connection control line; and
second connectors configured to control electrical connections between the first node and the second local nodes based on the voltage of the connection control line.

18. The display device of claim 17, wherein the first connectors electrically disconnect the first node and the first local nodes during a period in which the enable scan signal is output to the first output terminals, and
wherein the second connectors electrically disconnect the first node and the second local nodes during a period in which the enable initialization signal is output to the second output terminals.

19. An electronic device comprising:
a processor;
a display module for displaying an image based on image data supplied from the processor;
pixels comprised in the display module and connected to scan lines, to initialization lines, and to data lines; and
a scan driver in the display module, and comprising stage circuits configured to supply a scan signal to the scan lines and an initialization signal to the initialization lines, at least one of the stage circuits comprising:
a controller connected to a first power input terminal, to a second power input terminal, to a first carry input terminal, to a second carry input terminal, and to an initialization terminal, and configured to control a voltage of a connection control line;
a driver configured to control a voltage of a first node and a voltage of a second node;
first outputs configured to supply scan clock signals as an enable scan signal to first output terminals based on voltages of first local nodes;
second outputs configured to supply initialization clock signals as an enable initialization signal to second output terminals based on voltages of second local nodes;
first connectors configured to control electrical connections between the first node and the first local nodes based on a voltage of the connection control line; and
second connectors configured to control electrical connections between the first node and the second local nodes based on the voltage of the connection control line.

20. The electronic device of claim 19, wherein the first connectors electrically disconnect the first node and the first local nodes during a period in which the enable scan signal is output to the first output terminals, and
wherein the second connectors electrically disconnect the first node and the second local nodes during a period in which the enable initialization signal is output to the second output terminals.
